(19) United States
(12) Patent Application Publication
(10) Pub. No.: US 2024/0412647 A1
(43) Pub. Date: Dec. 12, 2024

(54) DETERMINATION DEVICE, MANAGEMENT SYSTEM, DETERMINATION METHOD, AND RECORDING MEDIUM

(71) Applicant: NEC Corporation, MInato-ku, Tokyo (JP)

(72) Inventors: Remi Tanaka, Tokyo (JP); Takeshi Shouta, Tokyo (JP); HIroyuki Kakinuma, Tokyo (JP); Tomoyuki Muto, Tokyo (JP)

(73) Assignee: NEC Corporation, Minato-ku, Tokyo (JP)

(21) Appl. No.: 18/702,063

(22) PCT Filed: Nov. 19, 2021
(86) PCT No.: PCT/JP2021/042552

§ 371 Date: Apr. 17, 2024

(51) Int. Cl. G08G 5/00; B60L 58/13

(52) U.S. Cl. CPC G08G 5/0039; B60L 58/13; G08G 5/0026; G08G 5/0056; G08G 5/006; G08G 5/0069; B60L 2200/10

(57) ABSTRACT

Provided is a determination device that includes a usage plan acquisition unit that acquires a usage plan of a corridor formed for navigation of a drone, a storage unit that stores reservation information of the corridor, a calculation unit that calculates a determination parameter relating to congestion in the corridor corresponding to the usage plan by referring to the reservation information, a prediction unit that predicts a congestion status of the corridor according to the calculated determination parameter, a determination unit that generates determination information relating to availability of the corridor according to the predicted congestion status of the corridor, and an output unit that outputs the determination information relating to availability of the corridor.

### TECHNICAL FIELD

The present disclosure relates to a determination device and the like that determine availability of a corridor according to a usage plan of a drone highway (corridor).

### BACKGROUND ART

There is an increasing need to operate drones in densely populated areas such as urban areas. To ensure safe and stable operation, maintenance of the drone highway (also referred to as a corridor) is being considered.

PTL 1 discloses a navigation system of a drone. PTL 1 discloses a drone highway configured to navigate a drone by using existing infrastructure such as power lines, roads, and pipelines. In the method of PTL 1, the drone collects environmental data relating to the heat of the infrastructure and the spectrum such as infrared rays and visible light. The drone compares the collected environmental data with data signatures associated with the drone highway to determine its position in that drone highway.

PTL 2 discloses a battery management device that presents a movable distance according to a situation of a planned moving route of an electric moving body. The device of PTL 2 acquires the charging rate of a power storage element and the environment information in the prophetic route of the electric moving body. The device of PTL 2 calculates the predicted power consumption amount based on the necessary power amount for the electric moving body to move along the scheduled route and the prediction of the power consumption amount in the facility mounted on the electric moving body from the acquired charging rate and environment information. The device of PTL 2 calculates a movable distance due to remaining power of the power storage element based on the calculated predicted power consumption amount and the charging rate.

### CITATION LIST

### Patent Literature

PTL 1: JP 2020-513122 A
PTL 2: WO 2021/038940 A

### SUMMARY OF INVENTION

### Technical Problem

According to the method of PTL 1, it is possible to navigate the drone over a long distance by controlling the movement of the drone according to the position of the drone on the drone highway. In PTL 1, it is not assumed that a plurality of drones simultaneously use the same drone highway. For example, if a plurality of drones simultaneously use the same drone highway, congestion may occur depending on the positional relationship of those drones. When a congestion occurs, the drone hovers and continues to stop, which may cause battery exhaustion or fuel exhaustion and crash.

PTL 2 discloses calculating a predicted power consumption amount using congestion information such as a congestion length for each section of a route, an average travel time for each time in the section, and an average speed. PTL 2 discloses using the congestion information relating to congestion that has already occurred, but does not disclose predicting congestion that may occur in advance. Therefore, even when the method of Patent Literature 2 is used, there is a possibility that battery exhaustion or fuel exhaustion may occur in a case where congestion has occurred during use of the route.

An object of the present disclosure is to provide a determination device and the like capable of resolving congestion that may occur in a corridor through which a drone navigates.

### Solution to Problem

A determination device according to one aspect of the present disclosure includes a usage plan acquisition unit that acquires a usage plan of a corridor formed for navigation of a drone, a storage unit that stores reservation information of the corridor, a calculation unit that calculates a determination parameter relating to congestion in the corridor corresponding to the usage plan by referring to the reservation information, a prediction unit that predicts a congestion status of the corridor according to the calculated determination parameter, a determination unit that generates determination information relating to availability of the corridor according to the predicted congestion status of the corridor, and an output unit that outputs the determination information relating to availability of the corridor.

In a determination method according to one aspect of the present disclosure, a computer acquires a usage plan of a corridor formed for navigation of a drone, stores reservation information of the corridor, calculates a determination parameter relating to congestion in the corridor corresponding to the usage plan by referring to the reservation information, predicts a congestion status of the corridor according to the calculated determination parameter, generates determination information relating to availability of the corridor according to the predicted congestion status of the corridor, and outputs the determination information relating to availability of the corridor.

A program according to one aspect of the present disclosure causes a computer to execute a process of acquiring a usage plan of a corridor formed for navigation of a drone, a process of storing reservation information of the corridor, a process of calculating a determination parameter relating to congestion in the corridor corresponding to the usage plan by referring to the reservation information, a process of predicting a congestion status of the corridor according to the calculated determination parameter, a process of generating determination information relating to availability of the corridor according to the predicted congestion status of the corridor, and a process of outputting the determination information relating to availability of the corridor.

### Advantageous Effects of Invention

According to the present disclosure, it is possible to provide a determination device and the like capable of resolving congestion that may occur in a corridor through which a drone navigates.

### BRIEF DESCRIPTION OF DRAWINGS

FIG. 1 is a block diagram illustrating an example of a configuration of a determination device according to a first example embodiment.

FIG. 2 is a conceptual diagram for explaining a formation example of a corridor to be reserved by the determination device according to the first example embodiment.

FIG. 3 is a conceptual diagram for explaining a formation example of a corridor to be reserved by the determination device according to the first example embodiment.

FIG. 4 is a conceptual diagram for explaining a formation example of a corridor to be reserved by the determination device according to the first example embodiment.

FIG. 5 is a conceptual diagram illustrating an input example of a usage plan input to the determination device according to the first example embodiment.

FIG. 6 is a table illustrating an example of reservation information stored in the determination device according to the first example embodiment.

FIG. 7 is a conceptual diagram illustrating an example of determination information output from the determination device according to the first example embodiment.

FIG. 8 is a table illustrating an example of reservation information stored in the determination device according to the first example embodiment.

FIG. 9 is a conceptual diagram illustrating an example of determination information output from the determination device according to the first example embodiment.

FIG. 10 is a conceptual diagram illustrating an example of a user interface for inputting a usage plan to the determination device according to the first example embodiment.

FIG. 11 is a conceptual diagram illustrating an input example to a user interface for inputting a usage plan to the determination device according to the first example embodiment.

FIG. 12 is a conceptual diagram illustrating an input example to a user interface for inputting a usage plan to the determination device according to the first example embodiment.

FIG. 13 is a conceptual diagram illustrating an input example to a user interface for inputting a usage plan to the determination device according to the first example embodiment.

FIG. 14 is a conceptual diagram illustrating an input example to a user interface for inputting a usage plan to the determination device according to the first example embodiment.

FIG. 15 is a conceptual diagram illustrating an example of determination information output from the determination device according to the first example embodiment.

FIG. 16 is a flowchart illustrating an example of an operation of the determination device according to the first example embodiment.

FIG. 17 is a flowchart for describing an example of a process in the case of the determination device according to the first example embodiment accepting an emergency request.

FIG. 18 is a block diagram illustrating an example of a configuration of a determination device according to a second example embodiment.

FIG. 19 is a conceptual diagram for explaining a formation example of a corridor to be reserved by the determination device according to the second example embodiment.

FIG. 20 is a conceptual diagram illustrating an input example of a usage plan input to the determination device according to the second example embodiment.

FIG. 21 is a table illustrating an example of reservation information stored in the determination device according to the second example embodiment.

FIG. 22 is a conceptual diagram illustrating an example of determination information output from the determination device according to the second example embodiment.

FIG. 23 is a table illustrating an example of reservation information stored in the determination device according to the second example embodiment.

FIG. 24 is a conceptual diagram illustrating an example of determination information output from the determination device according to the second example embodiment.

FIG. 25 is a conceptual diagram for explaining a formation example of a corridor to be reserved by the determination device according to the second example embodiment.

FIG. 26 is a conceptual diagram illustrating an example of determination information output from the determination device according to the second example embodiment.

FIG. 27 is a flowchart illustrating an example of an operation of the determination device according to the second example embodiment.

FIG. 28 is a block diagram illustrating an example of a configuration of a determination device according to a third example embodiment.

FIG. 29 is a conceptual diagram for explaining a formation example of a corridor to be reserved by the determination device according to the third example embodiment.

FIG. 30 is a conceptual diagram illustrating an example of determination information output from the determination device according to the third example embodiment.

FIG. 31 is a conceptual diagram for explaining a formation example of a corridor to be reserved by the determination device according to the third example embodiment.

FIG. 32 is a conceptual diagram illustrating an example of determination information output from the determination device according to the third example embodiment.

FIG. 33 is a flowchart illustrating an example of an operation of the determination device according to the third example embodiment.

FIG. 34 is a block diagram illustrating an example of a configuration of a management system according to a fourth example embodiment.

FIG. 35 is a conceptual diagram illustrating a control example of a drone using a corridor to be managed by a management system according to the fourth example embodiment.

FIG. 36 is a block diagram illustrating an example of a configuration of a management device of the management system according to the fourth example embodiment.

FIG. 37 is a conceptual diagram illustrating a control example of a drone using a corridor to be managed by the management system according to the fourth example embodiment.

FIG. 38 is a conceptual diagram illustrating an example of a configuration of a drone using a corridor to be managed by the management system according to the fourth example embodiment.

FIG. 39 is a block diagram illustrating an example of a configuration of a drone that uses a corridor to be managed by the management system according to the fourth example embodiment.

FIG. 40 is a flowchart for explaining an example of an operation of a management device included in the management system according to the fourth example embodiment.

FIG. 41 is a flowchart for explaining an example of a monitoring process by the management device included in the management system according to the fourth example embodiment.

FIG. 42 is a block diagram illustrating an example of a configuration of a determination device according to a fifth example embodiment.

FIG. 43 is a block illustrating an example of a hardware configuration that executes control and process of each example embodiment.

### EXAMPLE EMBODIMENT

Hereinafter, example embodiments of the present invention will be described with reference to the drawings. However, the example embodiments described below have technically preferable limitations for carrying out the present invention, but the scope of the invention is not limited to the following. Note that in all the drawings used in the following description of the example embodiments, the same reference numerals are given to the same parts unless there is a particular reason. Furthermore, in the following example embodiments, repeated description of similar configurations and operations may be omitted.

### First Example Embodiment

First, a determination device according to a first example embodiment will be described with reference to the drawings. The determination device of the present example embodiment determines availability of a corridor based on reservation information of a route (also referred to as a corridor) through which the drone navigates. Hereinafter, an example in which a flying drone navigates through a corridor formed above a river will be described. The corridor may be formed above not only a river but also a power transmission line, a railroad, a road, and the like. As long as the drone can navigate, the forming region of the corridor is not particularly limited. Furthermore, the drone is not limited to a flying type, and may be one that travels on the ground or one that navigates on a water surface or under water. The drone is not limited to an unmanned aerial vehicle, and may be a flying vehicle on which a person can board.

### (Configuration)

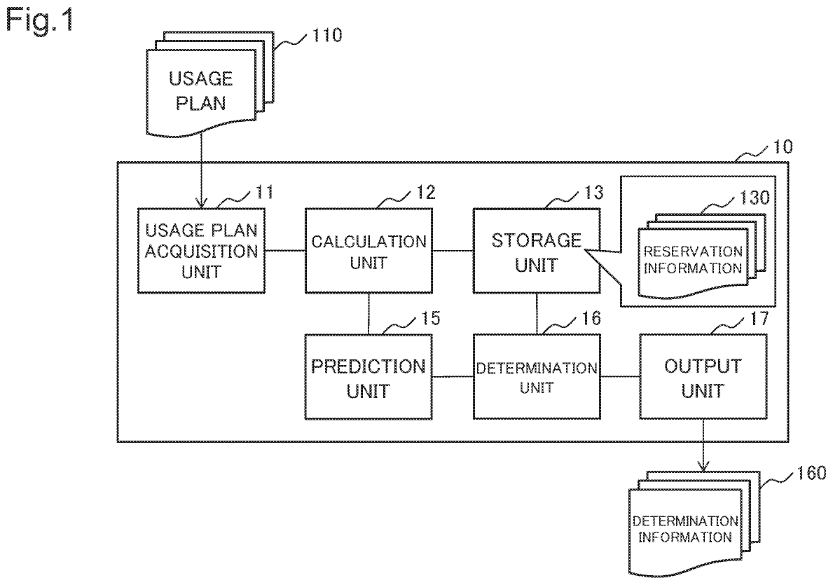

FIG. 1 is a block diagram illustrating an example of a configuration of a determination device 10 according to the present example embodiment. The determination device 10 includes a usage plan acquisition unit 11, a calculation unit 12, a storage unit 13, a prediction unit 15, a determination unit 16, and an output unit 17. FIG. 1 illustrates a usage plan 110 input to the usage plan acquisition unit 11 and determination information 160 output from the output unit 17.

### [Corridors]

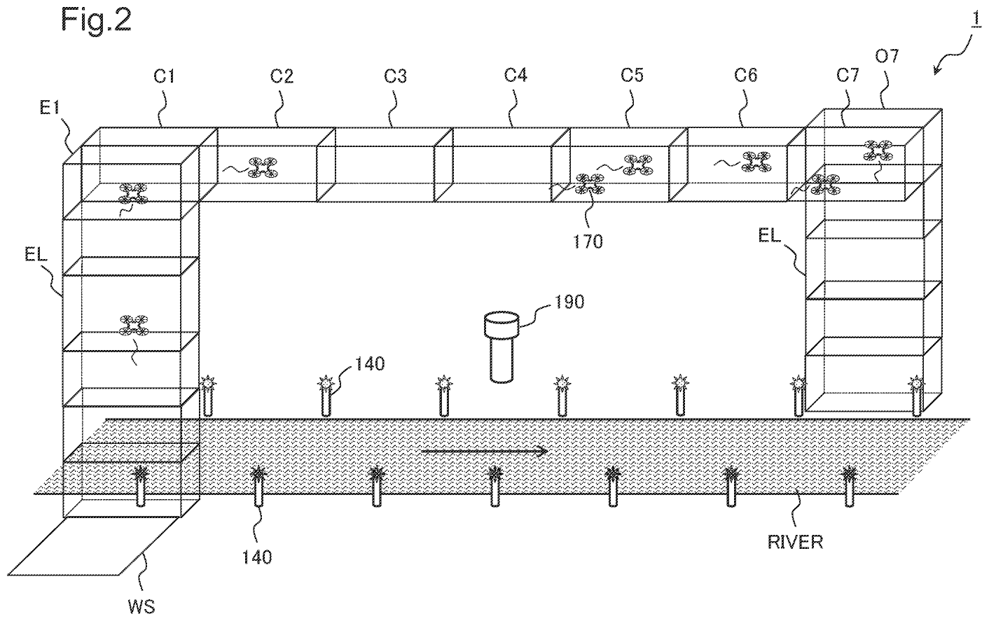

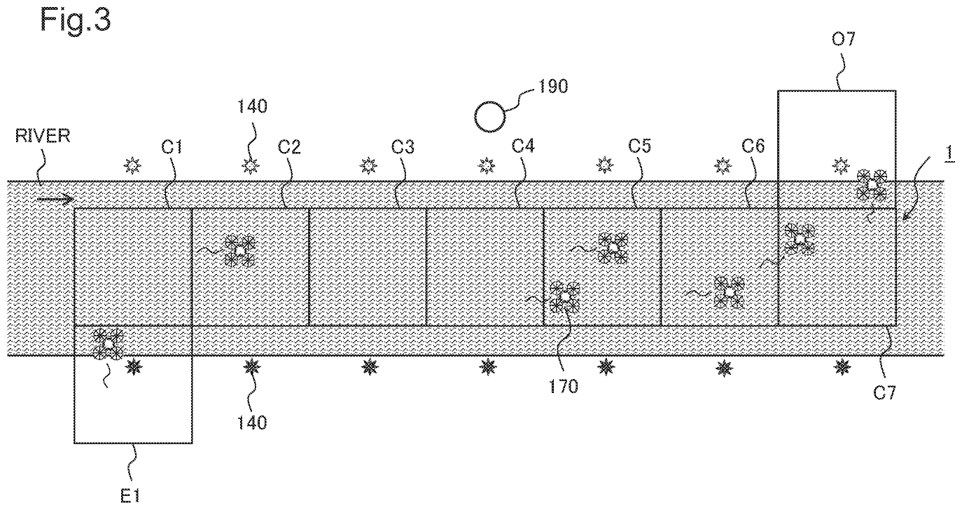

Before describing the configuration of the determination device 10 of FIG. 1, a corridor to be reserved by the determination device 10 will be described with reference to the drawings. FIG. 2 is a conceptual diagram illustrating an example of a corridor 1 formed above a river. FIG. 3 is a conceptual diagram of the corridor 1 as viewed from above. FIGS. 2 to 3 illustrate a state in which a plurality of drones 170 navigate the inside of the corridor 1.

For example, the corridor 1 is formed at an altitude of less than or equal to 150 m (meters) from the water surface of the river. In the example of FIGS. 2 to 3, the left side is upstream and the right side is downstream. In the following drawings, the direction in which a river flows is indicated by an arrow. When a river is viewed from upstream (left side) toward downstream (right side), a bank on the right side is referred to as a right bank, and a bank on the left side is referred to as a left bank.

The position where the corridor 1 is formed is defined by a plurality of guide lamps 140 arranged on both banks of the river. The plurality of guide lamps 140 emit light in different colors on the left and right banks. For example, the guide lamp 140 arranged on the left bank emits green light, and the guide lamp 140 arranged on the right bank emits red light. The light emitting color of the guide lamp 140 is not particularly limited as long as the guide lamp 140 installed at the bank on the same side emits light in the same color.

The advancing direction inside the corridor 1 is a direction from the left to the right in the plane of drawing of FIGS. 2 to 3. For example, the plurality of drones 170 are equipped with a camera (not illustrated) that captures an image of the lower side. The drone 170 navigates inside the corridor 1 according to the light emitting color of the guide lamp 140 included in an image of the lower side captured by the camera. For example, the drone 170 navigates according to the guide lamp 140 arranged on one bank of the river. For example, the drone 170 navigates according to the guide lamp 140 arranged on both banks of the river.

In the present example embodiment, an example in which the drone 170 navigates according to the light emitting color of the guide lamp 140 will be described. The drone 170 may navigate based on the image captured by the camera. For example, the drone 170 is configured to specify a position of the own device in a region where the corridor 1 is formed based on features extracted from the image, and to perform autonomous control in such a way as to navigate inside the corridor 1. For example, the drone 170 may be configured to specify a position of the own device in a region where the corridor 1 is formed based on position information of the own device, and to perform autonomous control in such a way as to navigate inside the corridor 1.

FIGS. 2 and 3 illustrate a waiting space WS, an up/down route EL, a corridor region C, an entrance region E, and an exit region O. The waiting space WS is a space where the drone 170 using the corridor waits. The up/down route EL is an airspace for traveling from the ground toward the corridor 1. The plurality of corridor regions C (C1 to C7) are airspaces serving as main lines of the corridor 1. The entrance region E is an airspace for the drone 170 to enter the corridor 1. FIGS. 2 and 3 illustrate the entrance region E1 for entering the corridor region C1. The exit region O is an airspace for the drone 170 to exit the corridor 1. FIGS. 2 and 3 illustrate the exit region O7 for exiting the corridor region C7.

A management tower 190 is disposed beside the river. The management tower 190 has a communication function and a camera. The management tower 190 receives a signal transmitted from the drone 170 navigating inside the corridor 1. The signal transmitted from the drone 170 includes transmitted information for identifying each drone 170. For example, the transmitted information is transmitted from a remote identifier (RID) device mounted on the drone 170. The transmitted information includes registration information, manufacturing number, position information, time, authentication information, and the like of each drone 170. For example, the drone 170 navigating inside the corridor 1 transmits the transmitted information at a transmission cycle of one or more times per second by a communication method such as Bluetooth (registered trademark). In addition, the management tower 190 captures an image of the drone 170 using the corridor 1. The management tower 190 transmits transmitted information included in the signals transmitted from the plurality of drones 170 and captured images to a management device (not illustrated) that manages the corridor 1. The transmitted information transmitted from the management tower 190 is used for management of the drone 170 using the corridor 1. For example, any of the plurality of guide lamps 140 arranged on both banks of the river may have the function of the management tower 190.

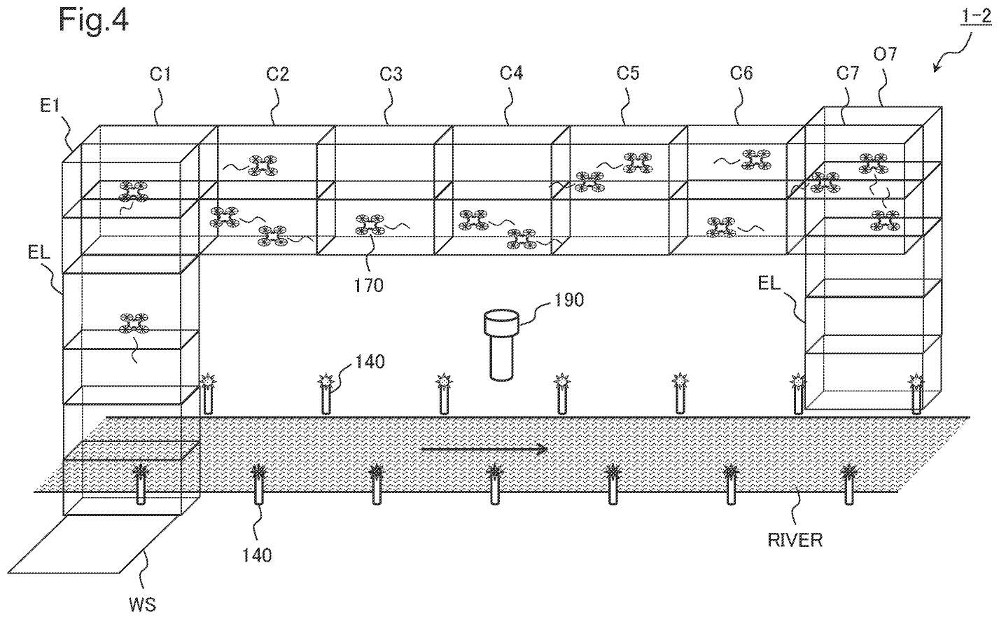

FIG. 4 is a conceptual diagram for describing another example (corridor 1-2) of the corridor 1 of FIGS. 2 and 3. The corridor 1-2 shows an example in which a downward route from upstream to downstream and an upward route from downstream to upstream are formed above a river. As illustrated in FIG. 4, a plurality of routes can be formed above the river. For example, the plurality of routes are formed according to altitude. For example, the plurality of routes may be formed in a plane parallel to the water surface of the river.

### [Determination Device]

Next, the usage plan acquisition unit 11, the calculation unit 12, the storage unit 13, the prediction unit 15, the determination unit 16, and the output unit 17 included in the determination device 10 will be described. For example, the determination device 10 is achieved by software implemented in a cloud or a server. For example, the determination device 10 may be provided as a dedicated terminal deployed on the side of a cloud or a server. Furthermore, the determination device 10 may be provided in the form of application software (hereinafter also referred to as an application.) installed in a portable terminal (not illustrated) such as a smartphone or a tablet carried by the user.

The usage plan acquisition unit 11 acquires the usage plan 110 of the corridor. The usage plan 110 is input by a user who wishes to use the corridor. The usage plan acquisition unit 11 outputs information included in the acquired usage plan 110 to the calculation unit 12.

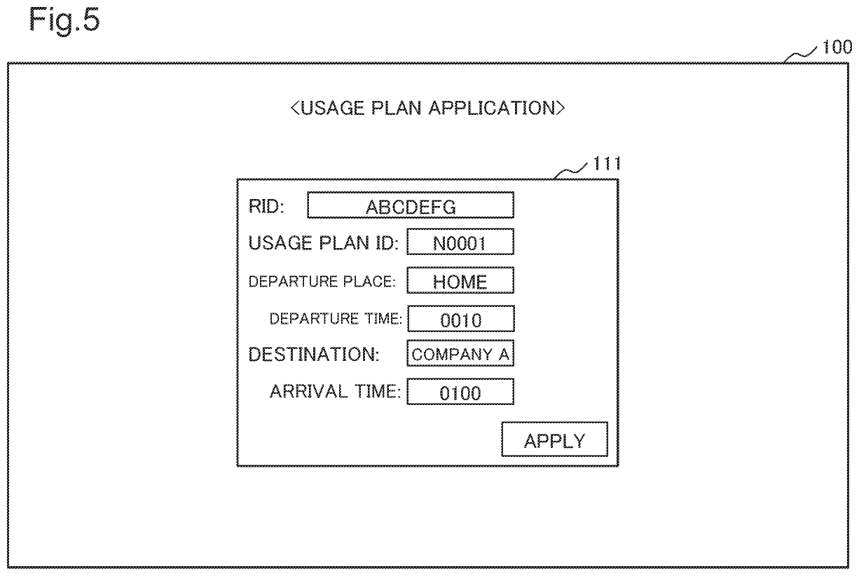

FIG. 5 is an example of an application in which the usage plan 110 input to the usage plan acquisition unit 11 is filled (usage plan application 111). FIG. 5 illustrates an example in which the usage plan application 111 is displayed on the screen of the terminal device 100 used by the user. For example, the terminal device 100 used by the user is a terminal having an input function, such as a smartphone, a tablet, or a personal computer. The terminal device 100 may be a general-purpose terminal to which a function of inputting the usage plan 110 of the corridor is added, or may be a dedicated terminal for inputting the usage plan 110 of the corridor.

The usage plan application 111 includes entry fields of a remote ID (RID), a usage plan ID, a departure place, a departure time, a destination, an arrival time, and the like. The RID is identification information unique to the drone 170 of the user. For example, the RID is registration information, a manufacturing number, authentication information, or the like included in the transmitted information of the individual drone 170. The RID may be transmitted information of the individual drone 170. The usage plan ID is an identification number for identifying each usage plan 110. The usage plan ID may be automatically assigned for each application of the usage plan 110. The departure place is a place where the drone 170 is scheduled to depart. The departure time is a time at which the drone 170 is scheduled to depart from the departure place. The destination is a place where the drone 170 is scheduled to arrive. The arrival time is a time at which the drone 170 is scheduled to arrive at the destination. The usage plan application 111 of FIG. 5 is an example, and may include entry fields other than the items illustrated in FIG. 5. For example, the usage plan application 111 may include an entry field of user information such as a name, an address, a telephone number, an e-mail address, and identification information of the user.

An example of the usage plan application 111 in FIG. 5 is a usage plan 110 having a usage plan ID of N0001 input for a drone 170 having an RID of “ABCDEFG”. The user who applies for the usage plan 110 applies for the usage plan application 111 of the corridor 1 in the route from departing home at 0:10 to arriving at company A at 1:00. For example, the usage plan 110 filled in the usage plan application 111 is applied by clicking/tapping an apply button in a state where a necessary entry field is filled.

The storage unit 13 stores the reservation information 130 of the corridor. The reservation information 130 includes information such as the number of drones 170 for which the corridor is being reserved (number of drones that made the reservation), the number of drones 170 that can use the corridor (upper limit number of drones), and the flow rate (density). The reservation information 130 may include information indicating the number of drones that can make a reservation and the availability of reservation.

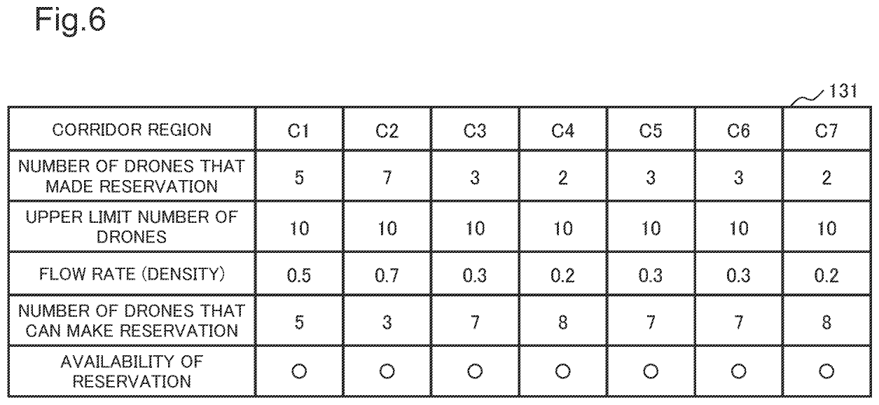

FIG. 6 illustrates an example (reservation information 131) of the reservation information 130 stored in the storage unit 13. The reservation information 131 in FIG. 6 includes information relating to the number of drones that made the reservation, the upper limit number of drones, the flow rate (density), the number of drones that can make a reservation, and the availability of reservation. FIG. 6 illustrates an example in which information for each of the corridor regions C is included in the reservation information 131. The reservation information 130 may store information for several corridor regions instead of for each of the corridor regions C. In addition, the reservation information 130 may store reservation information of the entire corridor instead of each corridor region C. FIG. 6 illustrates the reservation information 131 of the corridor in a certain time zone. The reservation information 130 may indicate a reservation status of the corridor in a timetable.

In the reservation information 131 of FIG. 6, for example, in the corridor region C1, the number of drones that made the reservation is 5, and the upper limit number of drones is 10. For example, the flow rate (density) in the corridor region C1 is a value (0.5) obtained by dividing the number of drones that made the reservation (5) by the upper limit number of drones (10). Furthermore, the number of drones that can make a reservation in the corridor region C1 is a value (5) obtained by subtracting the number of drones that made the reservation (5) from the upper limit number of drones (10). The flow rate (density) and the number of drones that can make a reservation can also be calculated for the corridor regions C2 to C7 other than the corridor region C1, similarly to the corridor region C1. The availability of reservation indicates reservation is possible/not possible at that time. In the example of the reservation information 131 of FIG. 6, reservation can be made (o) for all the corridor regions C1 to C7. The method of calculating the flow rate (density) of the corridor region C1 is not limited to the above method.

The calculation unit 12 acquires the usage plan 110 from the usage plan acquisition unit 11. In addition, the calculation unit 12 acquires the reservation information 130 of the corridor corresponding to the usage plan from the storage unit 13. In a case where a plurality of corridors are formed, the calculation unit 12 selects a corridor based on a departure place and a destination, a departure time, and an arrival time included in the usage plan. For example, the calculation unit 12 selects a corridor closest to the route of the departure place and the destination included in the usage plan. For example, the calculation unit 12 selects a corridor available for the departure time and the arrival time included in the usage plan.

The calculation unit 12 calculates a determination parameter in a case where the application for the usage plan is accepted based on the reservation information 130 of the corridor. The determination parameter is a value for determining availability of the corridor. The calculation unit 12 calculates a determination parameter relating to a time zone (also referred to as a planned time zone) from the departure time to the arrival time included in the usage plan. For example, the calculation unit 12 calculates, as determination parameters, the flow rate (density) of the drone 170 in the corridor in the planned time zone and the number of drones that can make a reservation in a case where the application for the usage plan is accepted. In a case where the number of drones 170 applied for in the usage plan is one, the calculation unit 12 calculates the determination parameter by adding 1 to the number of drones that has made the reservation included in the reservation information 130. In a case where a plurality of drones 170 are applied for in the usage plan, the calculation unit 12 adds the number of drones 170 for which an application is being made to the number of drones that has made the reservation included in the reservation information 130 to calculate a determination parameter. The calculation unit 12 outputs the calculated determination parameter of the drone 170 to the prediction unit 15.

For example, the calculation unit 12 calculates, as the determination parameter, a ratio of the number of drones that made the reservation with respect to the upper limit number of drones 170 for each corridor region C in the planned time zone corresponding to the usage plan 110. In this case, the determination parameter corresponds to the number of drones 170 (density) for each corridor region C. For example, the calculation unit 12 calculates the determination parameter J using the following Equation 1.

J=(R_{C}+N)/U (1)

In Equation 1 described above, R_{C} is the number of drones that made the reservation for the corridor region C at the time of accepting the usage plan. U is the number of drones that can make a reservation in the corridor region C at the time of accepting the usage plan. N is the number of drones 170 applied for in the usage plan 110.

For example, the calculation unit 12 may calculate, as the determination parameter, the number of drones 170 staying in the corridor region C for each time included in the planned time zone based on the position information and the moving speed of the drone 170. If the determination parameter is calculated for each time included in the planned time zone, more accurate determination can be made. For example, the calculation unit 12 calculates the determination parameter Jₜ at time t using the following Equation 2.

Jₜ=(R_{Ct}+Nₜ)/Uₜ (2)

In Equation 2 described above, R_{Ct} is the number of drones that made the reservation for the corridor region C at time t at the time of accepting the usage plan. Uₜ is the number of drones that can make a reservation for the corridor region C at time t at the time of accepting the usage plan. Nₜ is the number of drones 170 applied for in the usage plan 110 is expected to stay in the corridor region C at time t.

Equations 1 and 2 described above are examples in which the flow rate (density) of the drone 170 in the corridor in the planned time zone is calculated as a determination parameter. The calculation unit 12 may calculate the number of drones 170 in the corridor in the planned time zone as the determination parameter.

The prediction unit 15 predicts a congestion status of the corridor in the applied planned time zone using the determination parameter calculated by the calculation unit 12. The prediction unit 15 outputs the prediction result of the congestion status of the corridor to the determination unit 16.

When the determination parameter is the flow rate (density), the prediction unit 15 predicts the congestion status of the corridor according to the value of the determination parameter calculated by the calculation unit 12. When the determination parameter calculated by the calculation unit 12 is less than 1, the prediction unit 15 predicts that the corridor is not congested. When the determination parameter calculated by the calculation unit 12 is greater than or equal to 1, the prediction unit 15 predicts that the corridor is congested.

When the determination parameter is the number of drones, the prediction unit 15 predicts the congestion status of the corridor according to the magnitude relationship between the upper limit number of drones included in the reservation information 130 and the determination parameter calculated by the calculation unit 12. When the upper limit number of drones included in the reservation information 130 is greater than or equal to the determination parameter calculated by the calculation unit 12, the prediction unit 15 predicts that the corridor is not congested. On the other hand, when the upper limit number of drones included in the reservation information 130 is less than the determination parameter calculated by the calculation unit 12, the prediction unit 15 predicts that the corridor is congested.

The determination unit 16 determines to permit/not to permit the use of the corridor in accordance with the congestion status predicted by the prediction unit 15. When the prediction unit 15 predicts that the corridor is not congested, the determination unit 16 generates the determination information 160 indicating that the determination is permitted. For example, the determination unit 16 generates the determination information 160 including a determination result indicating that the application has been accepted, a usage condition including an entrance/exit region, a route, and the like of the corridor for which use is permitted, and the like. When the prediction unit 15 predicts that the corridor is congested, the determination unit 16 generates the determination information 160 indicating that the determination is not permitted. For example, the determination unit 16 generates the determination information 160 including a determination result indicating that the application has not been accepted, a usage condition such as an alternative plan, and the like.

The output unit 17 outputs the determination information 160 generated by the determination unit 16. For example, the determination information 160 output from the output unit 17 is output to the terminal device 100. The determination information 160 is displayed on the screen of the terminal device 100. For example, the determination information 160 output from the output unit 17 may be output to another system (not illustrated). The purpose of the determination information 160 output from the output unit 17 is not particularly limited.

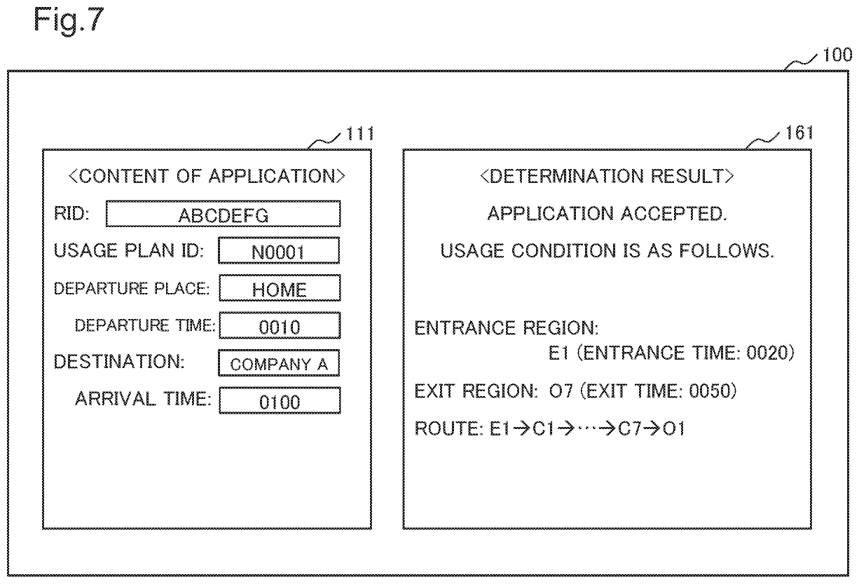

FIG. 7 is an example of displaying the determination information (determination information 161) on the screen of the terminal device 100. In FIG. 7, the usage plan application 111 is displayed side by side with the determination information 161. FIG. 7 illustrates determination information 161 in a case where use of the corridor is permitted. The determination information 161 includes a determination result “application accepted”. In addition, the determination information 161 includes usage conditions such as a time of entering the corridor via the entrance region E1 (entrance time), a time of exiting from the corridor via the exit region O7 (exit time), and a route. The user who has confirmed the determination result can use the corridor according to the usage condition.

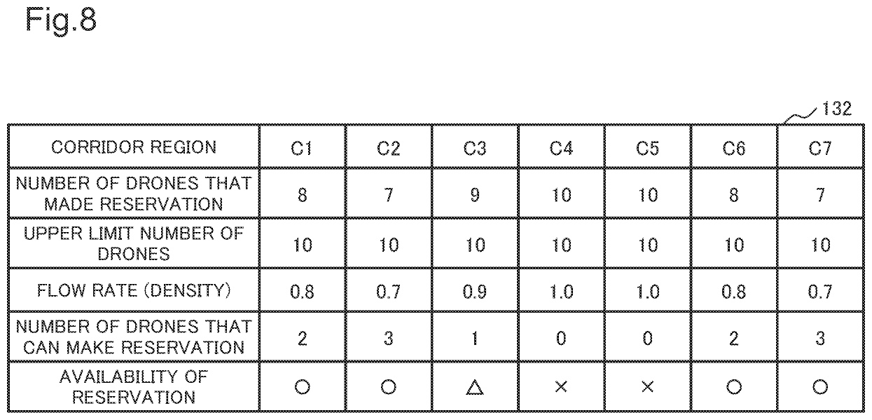

FIG. 8 illustrates another example (reservation information 130) of the reservation information 132 stored in the storage unit 13. FIG. 8 illustrates an example in which the reservation information 132 includes a corridor region C that cannot be reserved (x). Furthermore, the reservation information 132 in FIG. 8 also includes a corridor region C with few reservation spots where conditional reservation (A) can be made.

In the reservation information 132 of FIG. 8, for example, in the corridor region C1, the number of drones that made the reservation is 8, and the upper limit number of drones is 10. The flow rate (density) in the corridor region C1 is a value (0.8) obtained by dividing the number of drones that made the reservation (8) by the upper limit number of drones (10). Furthermore, the number of drones that can make a reservation in the corridor region C1 is a value (2) obtained by subtracting the number of drones that made the reservation (8) from the upper limit number of drones (10). That is, the remaining two drones can make reservation for the corridor region C1.

In the reservation information 132 of FIG. 8, for example, in the corridor region C4 and the corridor region C5, the number of drones that made the reservation is 10, and the upper limit number of drones is 10. The flow rates (densities) in the corridor regions C4 and C5 are values (1.0) obtained by dividing the number of drones that made the reservation (10) by the upper limit number of drones (10). The number of drones that can make a reservation in the corridor regions C4 and C5 is a value (0) obtained by subtracting the number of drones that made the reservation (10) from the upper limit number of drones (10). That is, the reservation is not possible for the corridor region C4 and the corridor region C5.

In the reservation information 132 of FIG. 8, for example, in the corridor region C3, the number of drones that made the reservation is 10, and the upper limit number of drones is 9. The flow rate (density) in the corridor region C3 is a value (0.9) obtained by dividing the number of drones that made the reservation (9) by the upper limit number of drones (10). Furthermore, the number of drones that can make a reservation in the corridor region C3 is a value (1) obtained by subtracting the number of drones that made the reservation (9) from the upper limit number of drones (10). That is, it is not possible to reserve two or more drones for the corridor region C3.

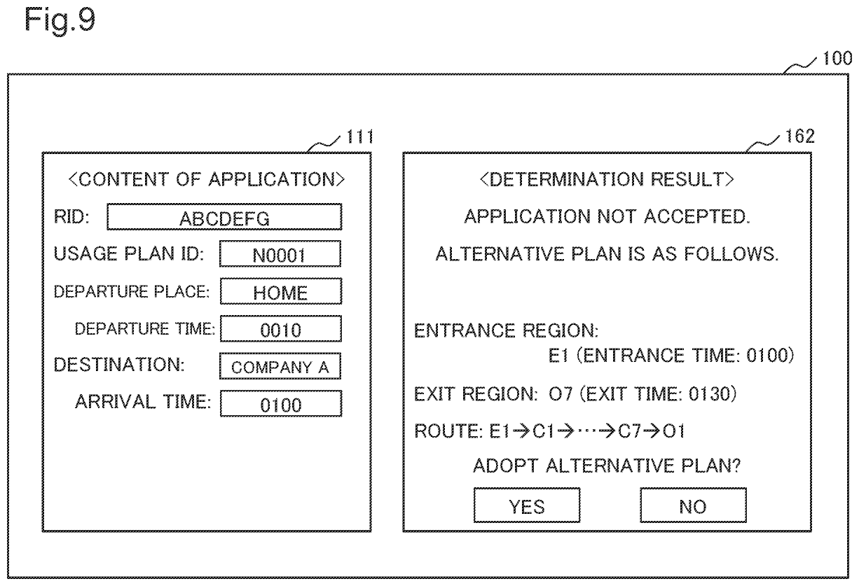

FIG. 9 is an example in which the determination information (determination information 162) corresponding to the reservation information 132 (FIG. 8) is displayed on the screen of the terminal device 100. In FIG. 9, the usage plan application 111 is displayed side by side with the determination information 162. FIG. 9 illustrates determination information 162 in a case where use of the corridor is not permitted. The determination information 162 includes a determination result “application accepted”. In addition, the determination information 161 includes alternative plans of the entrance time and the exit time. The alternative plan is a form of usage conditions. The alternative plan included in the determination information 162 of FIG. 9 is a plan in which the usage time of the corridor is shifted. The determination information 162 in FIG. 9 includes information “Adopt alternative plan?”. For example, the user who has confirmed the determination result confirms the alternative plan, and clicks/taps the “Yes” button when accepting the alternative plan. When the “Yes” button is clicked/tapped, the alternative plan is accepted. In addition, the user who has confirmed the determination result confirms the alternative plan, and clicks/taps the “No” button in a case where the alternative plan is not accepted. When the “No” button is clicked/tapped, the alternative plan is not accepted. For example, in a case where the “No” button is clicked/tapped, a user interface for filling in the usage plan application may be displayed on the screen of the terminal device 100.

### [User Interface]

Next, a user interface (UI) used to input the usage plan 110 will be described with reference to the drawings. Hereinafter, an example of a case in which the screen of the terminal device 100 is a touch panel will be described.

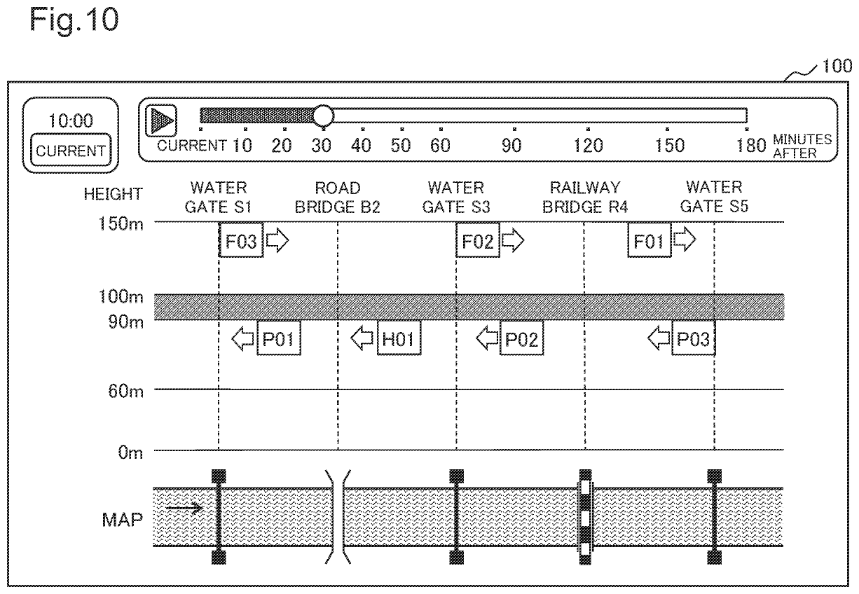

FIG. 10 is a conceptual diagram illustrating an example of a UI used to input the usage plan 110. In the example of FIG. 10, the UI is displayed on the screen of the terminal device 100 having the touch panel input function. A map including a river in which a corridor is formed in the sky is displayed on the lower side of the screen. The river is upstream on the left side and downstream on the right side. The map displayed on the screen may accurately represent the positional relationship of the object or may be simplified. The example of FIG. 10 illustrates an example in which a simplified map is displayed. On the map of FIG. 10, a water gate S1, a road bridge B2, a water gate S3, a railway bridge R4, and a water gate S5 are displayed. The water gate S1, the road bridge B2, the water gate S3, the railway bridge R4, and the water gate S5 are marks when using the corridor.

In the center of the screen of the terminal device 100 of FIG. 10, the reservation status of the corridor formed above the river is displayed. The reservation status of the corridor displayed on the screen of the terminal device 100 is acquired from the determination device 10. In the example of FIG. 10, information relating to a corridor formed above the river is displayed on the screen in association with the map. For example, the height displayed on the screen is an elevation. The height displayed on the screen may be a relative height with respect to the water surface of the river, the ground of the riverbed, or the like. A corridor in an advancing direction (upward) from the downstream toward the upstream is formed in the airspace at an elevation of 60 to 90 m. A corridor in an advancing direction (downward) from the upstream toward the downstream is formed in the airspace at an elevation of 100 to 150 m. The airspace in which the corridor is formed is also referred to as a corridor forming region. Corridors are not formed in airspaces having elevations of 0 to 60 m, 90 to 100 m, and 150 m or more. The airspace in which the corridor is not formed is also referred to as a corridor non-forming region.

For example, when a congestion is expected to occur or a congestion occurs in the corridor formed in the corridor forming region, the height at which the airspace of the upstream/downstream corridor is formed may be changed. For example, a corridor-non-forming region (90 to 100 m) sandwiched between the upstream/downstream corridors may be moved up and down in the height direction to adjust the range of the upstream/downstream corridors. For example, the corridor forming region may be expanded to a corridor non-forming region located above and below the corridor forming region. For example, when an emergency situation occurs, a part of the corridor non-forming region may be formed as an emergency corridor.

The current time is displayed on the upper left of the screen of FIG. 10. A slider for selecting a time is displayed on the right side of the portion where the current time is displayed (upper side of the screen). The time of the information displayed at the center of the screen can be changed by moving the slider to the left and right. At the center of the screen, identification information of a drone scheduled to use the corridor is displayed in association with the position in the corridor. The identification information of the drone scheduled to use the corridor displayed at the center of the screen indicates the position of the drone at the time set at the upper side of the screen. In the center of the screen of FIG. 10, the position of the drone 30 minutes after the current time (10:00) is displayed. For example, a drone (F03) scheduled to use a downstream corridor and a drone (P01) scheduled to use an upstream corridor are displayed in a corridor region between the water gate S1 and the road bridge B2. For example, the number of drones that use the corridor and the flow rate (density) may be displayed in association with the corridor region. According to the UI of FIG. 10, the drone scheduled to use the corridor can be visually grasped. In the following drawings, for convenience of description, a drone scheduled to use a corridor is omitted.

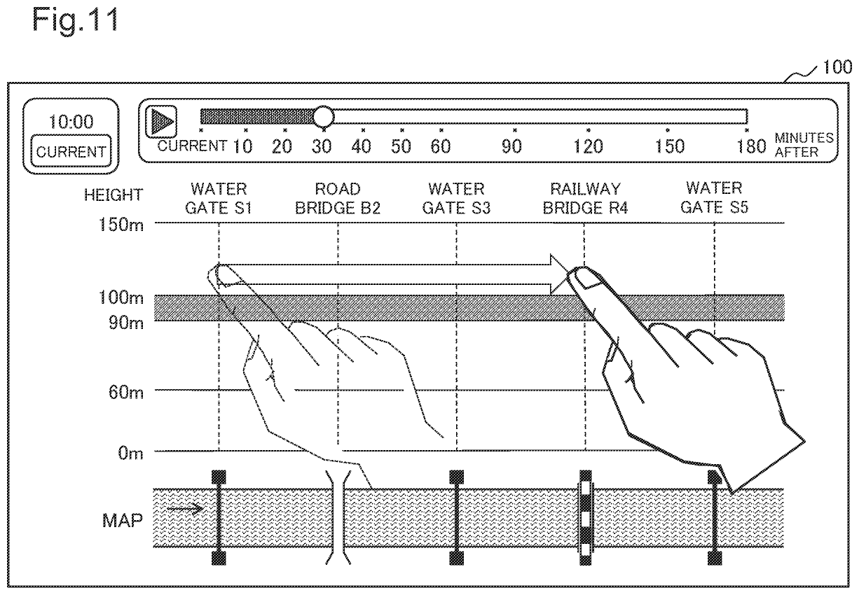

FIG. 11 illustrates an example in which selection of a corridor desired to be used is accepted in accordance with an operation on the corridor displayed on the screen. The example of FIG. 11 illustrates a state in which a corridor region from the water gate S1 to the railway bridge R4 is selected in a downward corridor 30 minutes after the current time (10:00).

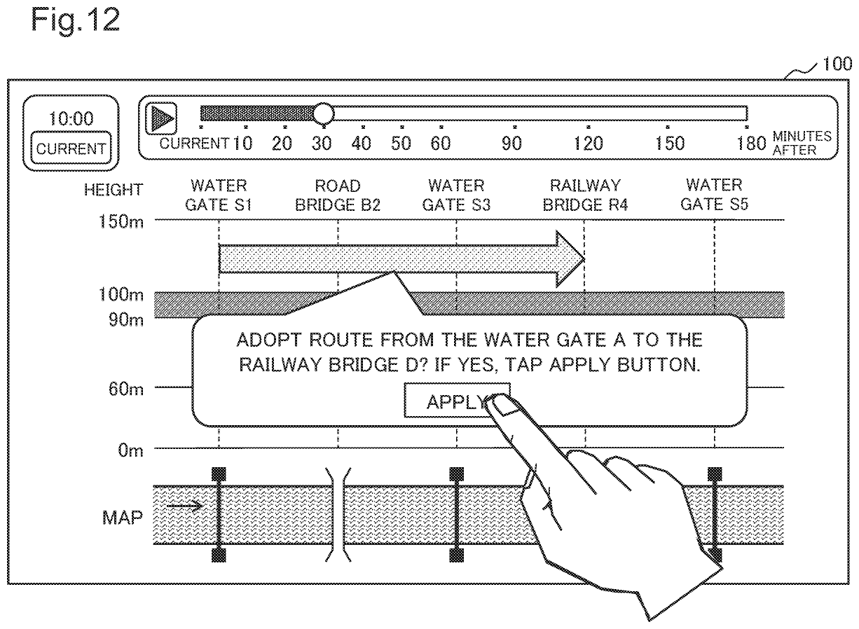

FIG. 12 is an example in which a sub window for applying for the usage plan 110 is displayed in a pop-up manner in accordance with selection of a corridor on the screen of the terminal device 100 as illustrated in FIG. 11. In the example of FIG. 12, character information “Adopt route from the water gate S1 to the railway bridge R4? If yes, tap apply button” is displayed. Under the character information, a button for accepting an application (apply button) is displayed. For example, in a case where the user who has confirmed the character information responds to the character information, the usage plan 110 is applied by tapping the apply button. For example, in a case where the user who has confirmed the character information does not respond to the character information, transition is made to a state where the usage plan 110 can be reapplied by tapping a screen region outside the popped up sub window.

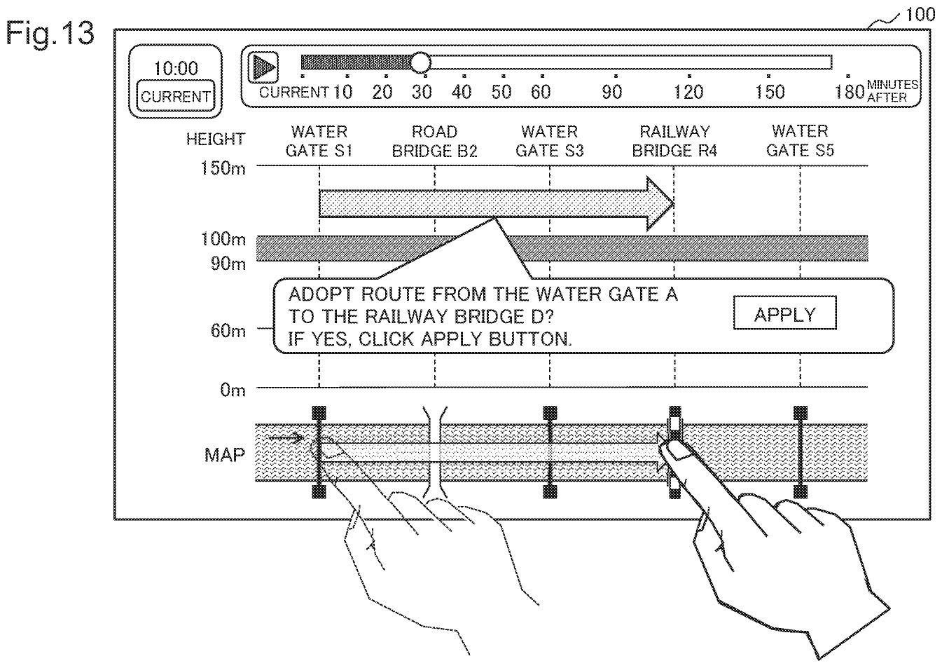

FIG. 13 illustrates an example of accepting selection of an available corridor in accordance with an operation on a river on a map displayed on the screen. The example of FIG. 13 illustrates a state in which a corridor region from the water gate S1 to the railway bridge R4 is selected in a downward corridor 30 minutes after the current time (10:00). In the example of FIG. 13, a sub window for applying for the usage plan 110 is displayed in a pop-up manner in accordance with an operation on the river on the screen of the terminal device 100. In the example of FIG. 13, character information “Adopt route from the water gate S1 to the railway bridge R4? If yes, tap apply button” is displayed. Under the character information, a button for accepting an application (apply button) is displayed. For example, in a case where the user who has confirmed the character information responds to the character information, the usage plan 110 is applied by tapping the apply button.

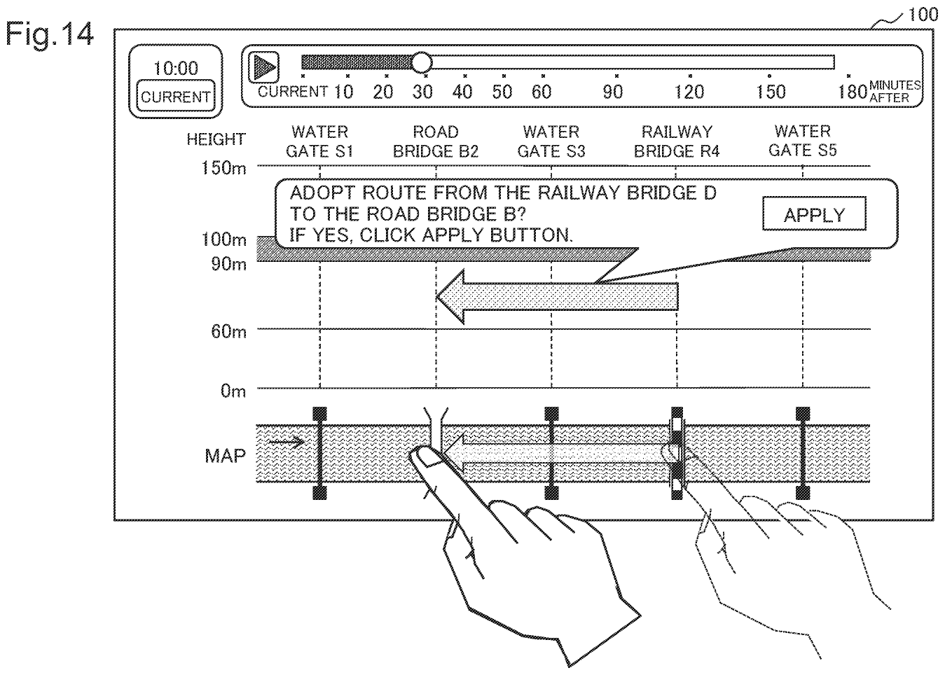

FIG. 14 illustrates another example of accepting selection of an available corridor in accordance with an operation on a river on a map displayed on the screen. The example of FIG. 14 illustrates a state in which a corridor region from a railway bridge R4 to a road bridge B2 is selected in an upward corridor 30 minutes after the current time (10:00). In the example of FIG. 14, a sub window for applying for the usage plan 110 is displayed in a pop-up manner in accordance with an operation on the river on the screen of the terminal device 100. In the example of FIG. 14, character information “Adopt route from the railway bridge R4 to the road bridge B2? If yes, tap apply button” is displayed. Under the character information, a button for accepting an application (apply button) is displayed. For example, in a case where the user who has confirmed the character information responds to the character information, the usage plan 110 is applied by tapping the apply button.

In the examples of FIGS. 13 to 14, since the corridor is selected based on the object displayed on the map, the usage plan 110 of the corridor can be more intuitively applied without being conscious of the up/down of the corridor or the like. In addition, in the examples of FIGS. 13 to 14, since a sub window for applying for the usage plan 110 is displayed in a pop-up manner in accordance with the operation on the river on the map, the input can be simplified as compared with the examples of FIGS. 11 to 12.

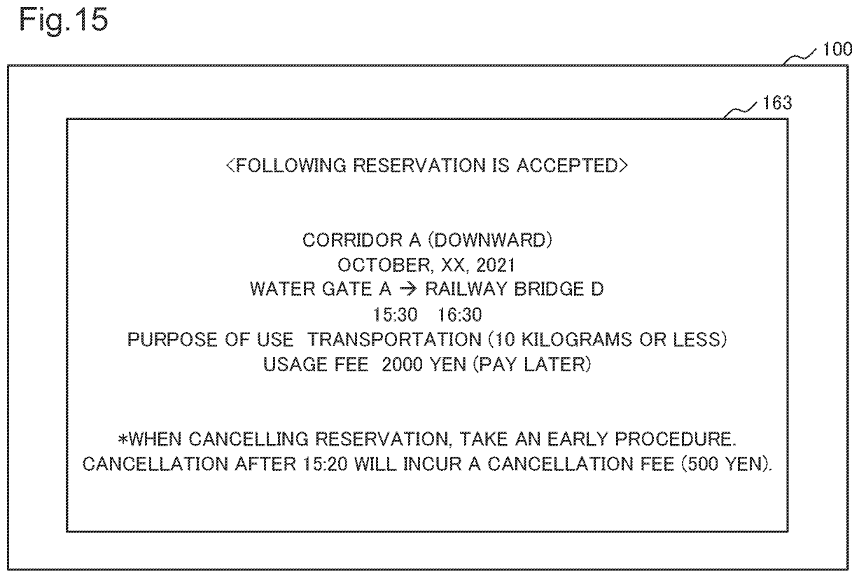

FIG. 15 is an example of displaying determination information (determination information 163) based on a determination according to an operation on the UI displayed on the screen of the terminal device 100. FIG. 7 illustrates determination information 163 in a case where use of the corridor is permitted. The determination information 163 includes a determination result “following reservation is accepted”. In addition, the determination information 163 includes usage conditions such as a reserved corridor, date and time, entrance region, exit region, entrance time, and exit time. For example, the determination information 163 may include information relating to a purpose of use, a usage fee, and the like. In the example of FIG. 15, the purpose of use is transportation (10 kilograms or less), and the usage fee is 2000 yen. For example, the determination information 163 may include information relating to cancellation, and the like. In the example of FIG. 15, character information “when cancelling reservation, take an early procedure. Cancellation after 15:20 will incur a cancellation fee (500 yen)” is displayed on the screen of the terminal device 100. The user who has confirmed the determination information can use the corridor according to the usage condition.

### (Operation)

Next, the operation of the determination device 10 will be described with reference to the drawings. Hereinafter, a flowchart relating to an operation example of the determination device 10 at the normal time and the emergency time will be described. The following flowchart summarizes the flow of operations of the determination device 10, and detailed operations and processes are omitted. The detailed operations and processes of the determination device 10 are as described above.

### [Normal Time]

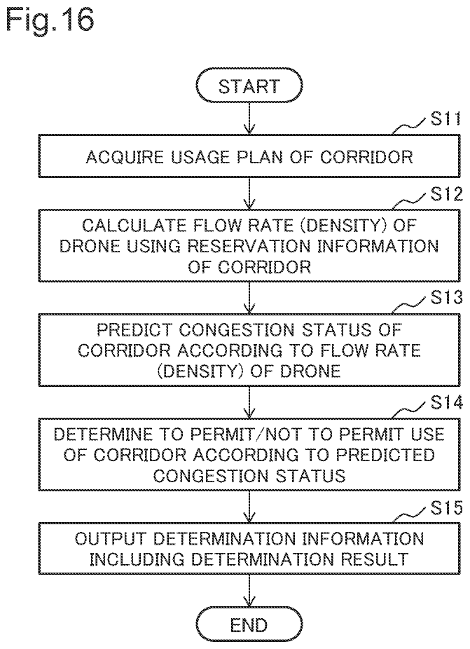

FIG. 16 is a flowchart relating to an operation example of the determination device 10 at the normal time. In the description along the flowchart of FIG. 16, the determination device 10 will be described as an operation subject.

In FIG. 16, first, the determination device 10 acquires a usage plan of a corridor (step S11).

Next, the determination device 10 calculates the flow rate of the drone in the corridor when the usage plan is accepted, using the reservation information of the corridor (step S12).

Next, the determination device 10 predicts a congestion status of the corridor when the usage plan is accepted according to the calculated flow rate of the drone (step S13).

Next, the determination device 10 determines to permit/not to permit the use of the corridor according to the congestion status predicted for the corridor when the usage plan is accepted (step S14).

Next, the determination device 10 outputs determination information including a determination result (step S15).

### [Emergency Time]

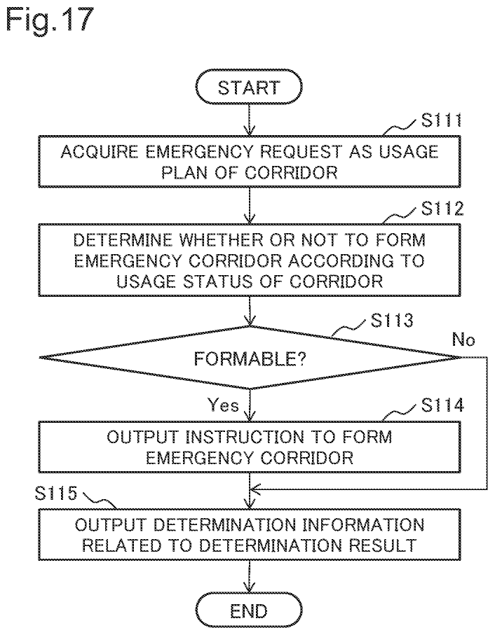

FIG. 17 is a flowchart relating to an operation example of the determination device 10 at the emergency time. In the description along the flowchart of FIG. 17, the determination device 10 will be described as an operation subject.

In FIG. 17, first, the determination device 10 acquires an emergency request as a usage plan of a corridor (step S111). For example, the emergency request is a usage plan for requesting formation of an emergency corridor when a disaster, an incident, an accident, or the like occurs. The emergency request is accepted from a special user such as a fire department, a police department, a hospital, a national government, or a local government. For example, it is preferable to determine not to have a user for a commercial purpose or a personal purpose make an emergency request. Note that it may be determined that even a user for a commercial purpose or a personal purpose may make an emergency request if an additional fee is paid. In that case, it may be determined to prioritize the emergency request from the special user.

Next, the determination device 10 determines whether to form an emergency corridor in accordance with the usage status of the corridor (step S112). For example, when an airspace in which an emergency corridor is formed, which is different from an airspace in which a corridor is formed in normal times, is vacant, the determination device 10 determines that the emergency corridor can be formed. For example, in a case where it is determined that the emergency request is prioritized even if the airspace in which the emergency corridor is formed is not vacant, the determination device 10 determines that the emergency corridor can be formed. The priority of using the emergency corridor may be determined in advance according to the user. For example, in a case where the corridor cannot be used due to environmental factors such as weather, convenience of a manager of the corridor, or the like, the determination device 10 determines that the formation of the emergency corridor is not possible. The formation of the emergency corridor may be agreed with the user by a prior contract regarding the use of the corridor or the like.

When the formation of the emergency corridor is possible (Yes in step S113), the determination device 10 outputs an instruction to form the emergency corridor (step S114). In a case where the formation of the emergency corridor is not possible (No in step S113), the process proceeds to step S115. For example, the instruction to form the emergency corridor is output to the guide lamp 140 and the management tower 190. The guide lamp 140 and the management tower 190 that have received the instruction to form the emergency corridor form the emergency corridor according to a predetermined rule. The rules and the like for forming the emergency corridor are not particularly limited.

After step S114 or when No in step S113, the determination device 10 outputs determination information relating to the determination result (step S15). When the instruction to form the emergency corridor is output (after step S114), the determination device 10 notifies the user of the determination result indicating that the use of the emergency corridor is permitted, the usage condition of the emergency corridor, and the like. For example, the usage condition of the emergency corridor includes conditions such as positions of an entrance region and an exit region, an entrance time and an exit time, and a route. When the formation of the emergency corridor is not possible (No in step S113), the determination device 10 notifies the user that the use of the emergency corridor is not permitted. For example, in a case where the use of the emergency corridor is not permitted, the determination device 10 may notify the user of information relating to an alternative plan for the use of the emergency corridor. An alternative plan for the use of the emergency corridor is, for example, a plan to use a road or a track along a river in which the corridor is formed, a water passage of the river, or the like. An alternative plan for the use of the emergency corridor is not particularly limited as long as it conforms to the significant points obtained by using the emergency corridor.

As described above, the determination device of the present example embodiment includes the usage plan acquisition unit, the calculation unit, the storage unit, the prediction unit, the determination unit, and the output unit. The usage plan acquisition unit acquires a usage plan of a corridor formed for navigation of the drone. The storage unit stores the reservation information of the corridor. The calculation unit refers to the reservation information and calculates a determination parameter relating to congestion in the corridor corresponding to the usage plan. The prediction unit predicts a congestion status of the corridor according to the calculated determination parameter. The determination unit generates determination information including a determination result regarding availability of the corridor and a usage condition of the corridor according to the predicted congestion status of the corridor. For example, the determination unit permits the use of the corridor when it is predicted that congestion does not occur in the corridor corresponding to the acceptance of the usage plan, and does not permit the use of the corridor when it is predicted that congestion occurs in the corridor corresponding to the acceptance of the usage plan. The output unit outputs determination information relating to the use of the corridor.

The determination device according to the present example embodiment predicts a congestion status that may occur in the corridor when the usage plan is accepted in response to the application for the usage plan. The determination device according to the present example embodiment determines to permit/not to permit the use of the corridor according to the predicted congestion status. Therefore, according to the present example embodiment, it is possible to resolve congestion that may occur in a corridor through which a drone navigates.

In one aspect of the present example embodiment, in a case where it is predicted that congestion occurs in a corridor according to acceptance of a usage plan, the determination unit presents an alternative plan regarding the use of the corridor. According to the present aspect, even if the usage plan is not followed, a corridor in which no congestion has occurred can be used based on the usage plan.

In one aspect of the present example embodiment, the prediction unit predicts the congestion status of the corridor according to the ratio of the number of drones that made the reservation corresponding to the usage plan with respect to the upper limit number of drones allowed for each of a plurality of corridor regions constituting the corridor. For example, the prediction unit predicts that no traffic congestion will occur in the corridor when the ratio of the number of drones that made the reservation corresponding to the usage plan with respect to the upper limit number of drones allowed for each of the plurality of corridor regions constituting the corridor is less than or equal to 1. For example, the prediction unit causes congestion in the corridor when the ratio of the number of drones that made the reservation corresponding to the usage plan with respect to the upper limit number of drones allowed for each of the plurality of corridor regions constituting the corridor exceeds one. According to the present aspect, since the congestion status is predicted according to the flow rate (density) of the drone allowed for each corridor region, the congestion occurring in the corridor can be more accurately resolved.

In one aspect of the present example embodiment, the prediction unit predicts the congestion status of the corridor according to a value obtained by subtracting the number of drones that made the reservation corresponding to the usage plan from the upper limit number of drones allowed for each of the plurality of corridor regions constituting the corridor. For example, in a case where a value obtained by subtracting the number of drones that made the reservation corresponding to the usage plan from the upper limit number of drones allowed for each of the plurality of corridor regions constituting the corridor is greater than or equal to 0, the prediction unit predicts that no congestion will occur in the corridor. For example, in a case where a value obtained by subtracting the number of drones that made the reservation corresponding to the usage plan from the upper limit number of drones allowed for each of the plurality of corridor regions constituting the corridor is less than 0, the prediction unit predicts that congestion will occur in the corridor. According to the present aspect, since the congestion status is predicted according to the number of drones allowed for each corridor region, the congestion occurring in the corridor can be more accurately resolved.

In one aspect of the present example embodiment, the output unit outputs the reservation status of the corridor to the terminal device used by the user who has applied for the usage plan, and displays the reservation status of the corridor on the screen of the terminal device used by the user. According to the present aspect, the user who has applied for the usage plan can accurately recognize the reservation status of the corridor displayed on the screen of the terminal device.

In one aspect of the present example embodiment, the usage plan acquisition unit acquires a usage plan input according to an operation for a reservation status of a corridor displayed on a terminal device. The output unit outputs the determination information determined according to the usage plan to the terminal device. In the present aspect, availability of the corridor is determined based on reservation information input according to an operation on the terminal device. According to the present aspect, the user can accurately recognize the reservation status of the corridor by outputting the determination information including the determination result according to the operation on the terminal device to the terminal device.

In one aspect of the present example embodiment, in a case where the emergency request of the corridor is acquired as the usage plan, the determination device determines whether to form the emergency corridor according to the usage status of the corridor. When the formation of the emergency corridor is possible, the determination device outputs an instruction to form the emergency corridor to the management device. The determination device outputs determination information including a determination result relating to use of the emergency corridor to the request source of the emergency request. The emergency corridor is formed in response to an instruction to form the emergency corridor output from the determination device. According to the present aspect, in a situation where congestion is occurring in a corridor, an emergency corridor in response to an emergency request can be formed even if the formed corridor cannot be used.

### Second Example Embodiment

Next, a determination device according to a second example embodiment will be described with reference to the drawings. The determination device of the present example embodiment determines availability of the corridor based on the charge amount of the drone in addition to the reservation information of the route (also referred to as the corridor) through which the drone navigates. In the present example embodiment, a corridor and a drone are similar to those in the first example embodiment.

### (Configuration)

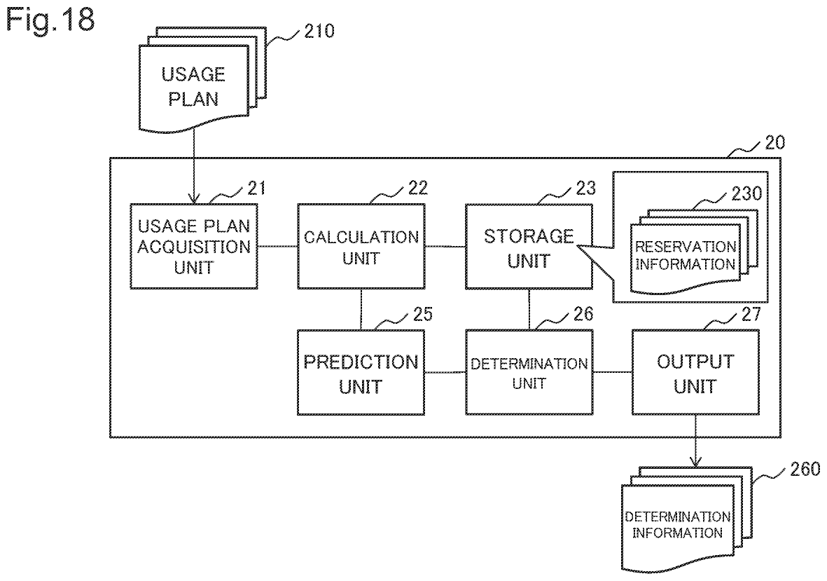

FIG. 18 is a block diagram illustrating an example of a configuration of a determination device 20 according to the present example embodiment. The determination device 20 includes a usage plan acquisition unit 21, a calculation unit 22, a storage unit 23, a prediction unit 25, a determination unit 26, and an output unit 27. FIG. 18 illustrates a usage plan 210 input to the usage plan acquisition unit 21 and determination information 260 output from the output unit 27.

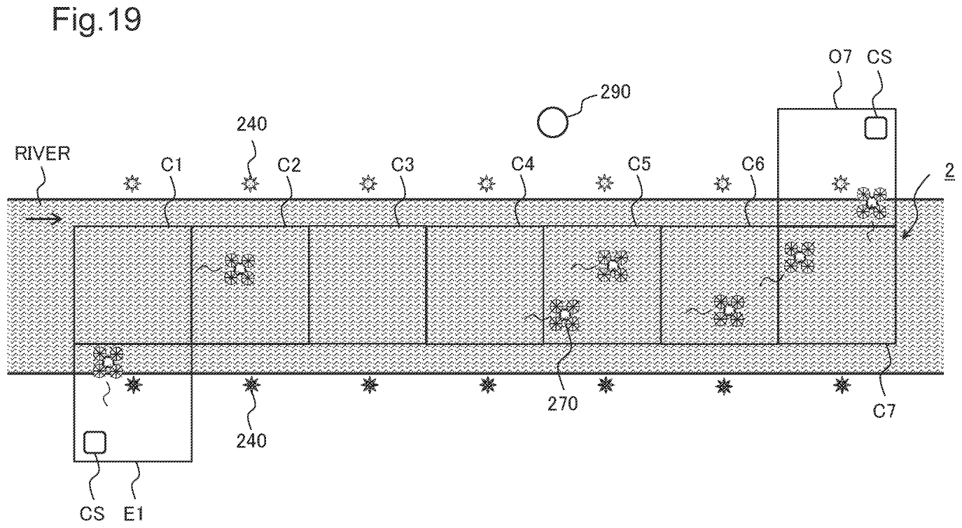

FIG. 19 is a conceptual diagram illustrating an example of a corridor 2 formed above a river. FIG. 19 is a conceptual diagram of the corridor 2 as viewed from above. FIG. 19 illustrates a state in which a plurality of drones 270 navigate the inside of the corridor 2. The corridor 2 of the present example embodiment is similar to the corridor 1 of the first example embodiment.

The position where the corridor 2 is formed is defined by a plurality of guide lamps 240 arranged on both banks of the river. The arrangement and light emission of the guide lamp 240 are similar to those in the first example embodiment. The advancing direction inside the corridor 2 is a direction from the left to the right in the plane of drawing of FIG. 19. For example, the drone 270 navigates inside the corridor 2 according to the light emitting color of the guide lamp 240 included in the image of the lower side captured by the camera. In addition, a management tower 290 is disposed beside the river. The management tower 290 has the same configuration as the management tower 190 of the first example embodiment.

FIG. 19 illustrates a corridor region C, an entrance region E, and an exit region O. In FIG. 19, the waiting space and the up/down route are omitted. The corridor region C, the entrance region E, and the exit region O are similar to those of the first example embodiment. In the example of FIG. 19, the charging station CS is illustrated on the ground on the lower side of the entrance region E and the exit region O. The charging station CS is a facility for supplying power to the drone 270. For example, in the charging station CS, power is supplied to the drone 270 by wireless power supply. For example, in the charging station CS, power may be supplied to the drone 270 by wired power supply using a cable. The charging station CS is not particularly limited as long as power can be supplied to the drone 270.

The usage plan acquisition unit 21 has a configuration similar to that of the usage plan acquisition unit 11 of the first example embodiment. The usage plan acquisition unit 21 acquires the usage plan 210 of the corridor. The usage plan 210 is input by a user who wishes to use the corridor. The usage plan acquisition unit 21 outputs information included in the acquired usage plan 210 to the calculation unit 22.

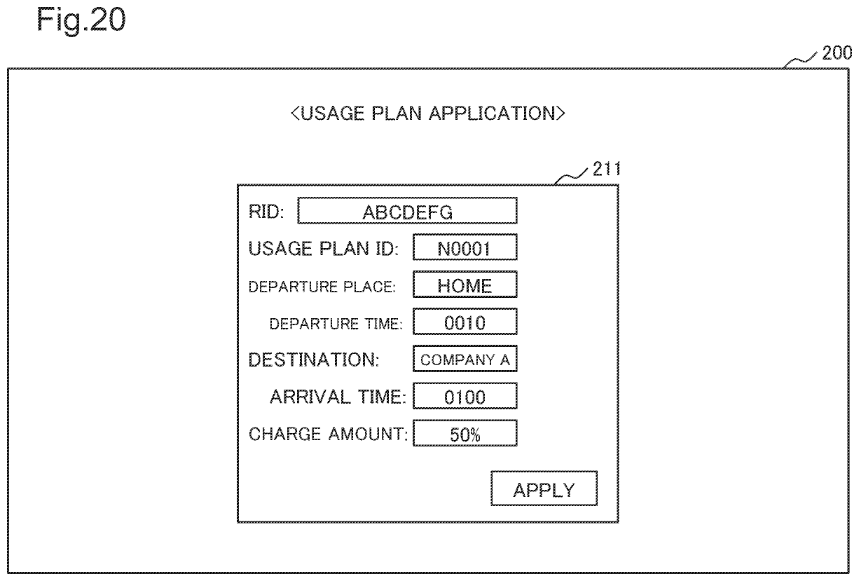

FIG. 20 is an example of an application in which the usage plan 210 input to the usage plan acquisition unit 21 is filled (usage plan application 211). The usage plan application 211 of FIG. 20 is similar to the usage plan application 111 (FIG. 5) of the first example embodiment except that there is a field for writing the charge amount. FIG. 20 illustrates an example in which the usage plan application 211 is displayed on the screen of the terminal device 200 used by the user.

The usage plan application 211 includes entry fields of a Remote ID (RID), a usage plan ID, a departure place, a departure time, a destination, an arrival time, a charge amount and the like. Information filled in the Remote ID (RID), the usage plan ID, the departure place, the departure time, the destination, and the arrival time is similar to that in the usage plan application 111 (FIG. 5) of the first example embodiment. In the field of the charge amount, the charge amount of the drone 270 scheduled to be used in the corridor 2 is filled. In the example of FIG. 20, the charge amount is expressed in % (percent). The charge amount may be expressed by a power supply capacity or the like instead of % (percent). In addition, the navigable distance may be displayed according to the charge amount according to the charge amount. The usage plan application 211 of FIG. 20 is an example, and may include entry fields other than the items illustrated in FIG. 20. For example, the usage plan application 211 may include an entry field of user information such as a name, an address, a telephone number, an e-mail address, and identification information of the user. For example, the usage plan 210 filled in the usage plan application 211 is applied by clicking/tapping an apply button in a state where necessary entry fields are filled.

The storage unit 23 has the same configuration as the storage unit 13 of the first example embodiment. The storage unit 23 stores the reservation information 230 of the corridor. The reservation information 230 includes information such as the number of drones 270 for which the corridor is being reserved (number of drones that made the reservation), the number of drones 270 that can use the corridor (upper limit number of drones), and the flow rate (density). The reservation information 230 may include information indicating the number of drones that can make a reservation and the availability of reservation. In addition, the reservation information 230 may include information such as the number of chargeable drones, the number of charging reservations, and the charging vacancies in the corridor region, the entrance region, the exit region, and the like.

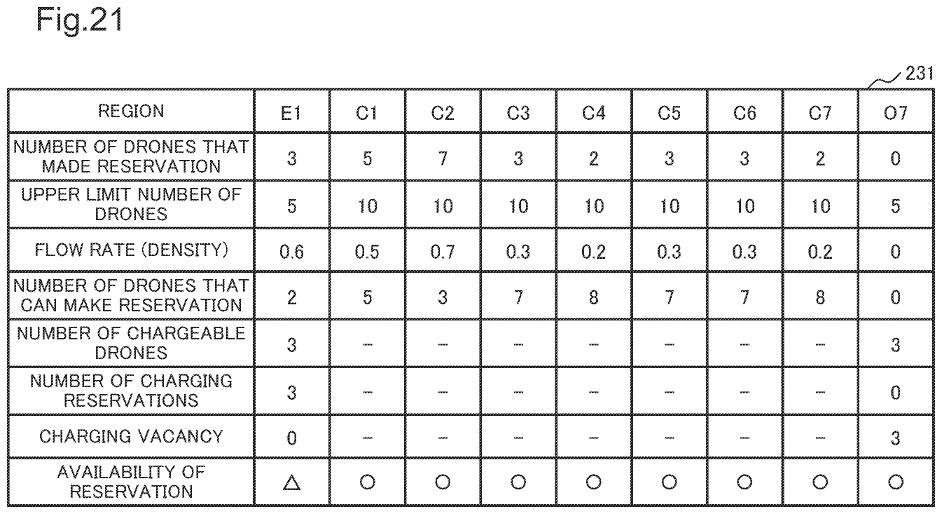

FIG. 21 illustrates an example (reservation information 231) of the reservation information 230 stored in the storage unit 23. Reservation information 231 in FIG. 21 includes information on the number of drones that made the reservation, the upper limit number of drones, the flow rate (density), the number of drones that can make reservation, availability of reservation, the number of chargeable drones, the number of charging reservations, and the charging vacancies. FIG. 21 illustrates an example in which information for each region such as the entrance region E, the exit region O, and the corridor region C is included in the reservation information 231. The reservation information 230 may store information for several regions instead of for each region. In addition, the reservation information 230 may store reservation information of the entire corridor instead of each region. FIG. 21 illustrates the reservation information 231 of the corridor in a certain time zone. The reservation information 230 may indicate a reservation status of the corridor in a timetable.

In the reservation information 231 of FIG. 21, for example, in the entrance region E1, the number of drones that made the reservation is 3, and the upper limit number of drones is 5. The flow rate (density) of the entrance region E1 is a value (0.6) obtained by dividing the number of drones that made the reservation (3) by the upper limit number of drones (5). The number of drones that can make a reservation in the entrance regions E1 is a value (2) obtained by subtracting the number of drones that made the reservation (3) from the upper limit number of drones (5). The flow rate (density) and the number of drones that can make a reservation can be calculated in the region other than the entrance region E1 similarly to the entrance region E1. The corridor can be reserved based on the flow rate (density) of the entrance region E1 and the number of drones that can make a reservation. However, in the entrance region E1, a numerical value (charging vacancy) obtained by subtracting the number of charge reservations (3) from the number of chargeable drones (3) is 0. That is, the drone 270 cannot be charged in the entrance region E1 of the corridor. The availability of reservation indicates reservation is possible/not possible at that time. In the example of the reservation information 231 of FIG. 21, reservation can be made (∘) for the region other than the entrance region E1. However, the conditional reservation can be made (Δ) for the entrance region E1. When the conditional reservation can be made (Δ), this indicates that the reservation is possible when charging is unnecessary in the entrance region E1. That is, when conditional reservation can be made (Δ), this indicates that the reservation is impossible when charging is necessary in the entrance region E1.

The calculation unit 22 has the same configuration as the calculation unit 12 of the first example embodiment. The calculation unit 22 acquires the usage plan 210 from the usage plan acquisition unit 21. In addition, the calculation unit 22 acquires the reservation information 230 of the corridor corresponding to the usage plan 210 from the storage unit 23.

The calculation unit 22 calculates a determination parameter in a case where the application for the usage plan 210 is accepted based on the reservation information 230 of the corridor. The calculation unit 22 calculates a determination parameter relating to a time zone (also referred to as a plan time zone) from the departure time to the arrival time included in the usage plan 210. For example, the calculation unit 22 calculates, as the determination parameter, the flow rate (density) of the drone 270 in the corridor in the planned time zone and the number of drones that can make a reservation in a case where the application for the usage plan 210 is accepted. The calculation unit 22 outputs the calculated determination parameter to the prediction unit 25.

The prediction unit 25 has the same configuration as the prediction unit 15 of the first example embodiment. The prediction unit 25 predicts a congestion status of the corridor in the applied planned time zone using the determination parameter calculated by the calculation unit 22. The prediction unit 25 outputs the prediction result of the congestion status of the corridor to the determination unit 26.

The determination unit 26 determines to permit/not to permit the use of the corridor in accordance with the congestion status predicted by the prediction unit 25 and the charge amount included in the usage plan 210. In a case where there is no region that can be conditionally reserved, the determination unit 26 determines to permit/not to permit the use of the corridor according to the congestion status predicted by the prediction unit 25. In a case where the prediction unit 15 predicts that the corridor is not congested and there is a region that can be conditionally reserved, the determination unit 26 determines to permit/not to permit the use of the corridor according to the presence or absence of charging vacancy of the charging station CS. In a case where there is a charging vacancy in the charging station CS, the determination unit 26 permits the use of the corridor. The determination unit 26 generates determination information 260 indicating that the determination is permitted. For example, the determination unit 26 generates the determination information 260 including a determination result indicating that the application has been accepted, a usage condition including an entrance/exit region, a route, and the like of the corridor for which use is permitted, and the like. In a case where the prediction unit 15 predicts that the corridor is congested or in a case where there is no charging vacancy in the charging station CS, the determination unit 26 generates the determination information 260 indicating that the determination is not permitted. For example, the determination unit 26 generates the determination information 260 including a determination result indicating that the application has not been accepted, a usage condition such as an alternative plan, and the like.

For example, the determination unit 26 may determine the availability of the corridor based on the navigable distance corresponding to the charge amount of the drone 270. In a case where the availability of the corridor is determined based on the navigable distance, a distance from a departure place to a destination when passing through the corridor scheduled to be used may be set as the scheduled navigation distance. The distance from the departure place to the destination when passing through the corridor scheduled to be used may be calculated including the power consumed when the drone 270 is raised/lowered. For example, in a case where the navigable distance corresponding to the charge amount of the drone 270 exceeds the scheduled navigation distance of the drone 270, the determination unit 26 permits the use of the corridor. For example, in a case where the navigable distance corresponding to the charge amount of the drone 270 is less than the scheduled navigation distance of the drone 270, the determination unit 26 permits the use of the corridor on condition that the drone 270 is charged. The method of calculating the navigable distance and the scheduled navigation distance is not limited to the above example.

The output unit 27 outputs the determination information 260 generated by the determination unit 26. For example, the determination information 260 output from the output unit 27 is output to the terminal device 200. The determination information 260 is displayed on the screen of the terminal device 200. For example, the determination information 260 output from the output unit 27 may be output to another system (not illustrated). The purpose of the determination information 260 output from the output unit 27 is not particularly limited.

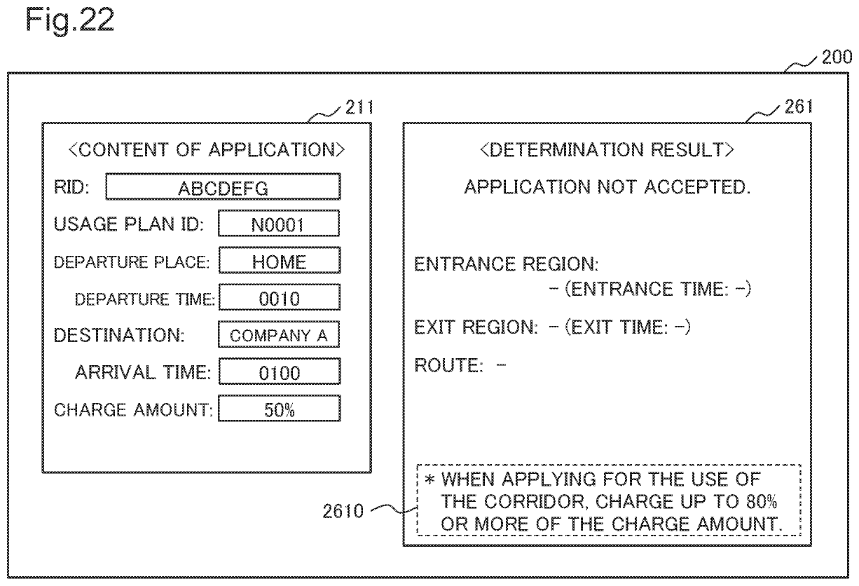

FIG. 22 illustrates an example in which the determination information (determination information 261) based on the reservation information 231 in FIG. 21 is displayed on the screen of the terminal device 200. In FIG. 21, the usage plan application 211 is displayed side by side with the determination information 261. FIG. 21 illustrates determination information 261 in a case where use of the corridor is not permitted. The determination information 261 includes a determination result “application not accepted”. In addition, caution information 2610 at the time of applying for use of the corridor is displayed in the determination information 261. In the example of FIG. 22, caution information 2610 indicating “When applying for use of the corridor, charge up to 80% or more of the charge amount” is displayed. The user who has confirmed the determination result can know the cautionary note at the time of applying for the use of the corridor by checking the caution information 2610.

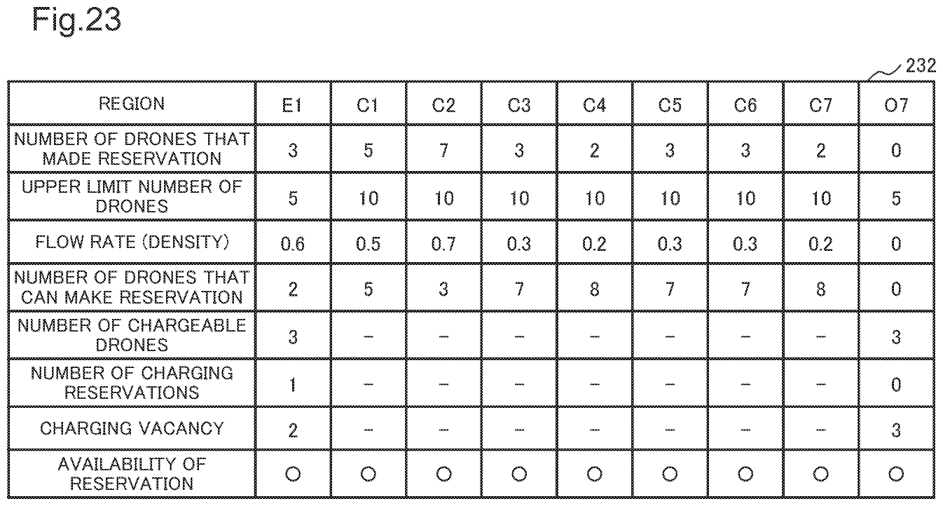

FIG. 23 illustrates another example (reservation information 232) of the reservation information 230 stored in the storage unit 23. The reservation information 232 of FIG. 23 does not include the region where conditional reservation is permitted (Δ) or reservation is not permitted (x). That is, the charging station CS in the entrance region E1 and the exit region O7 has vacancy.

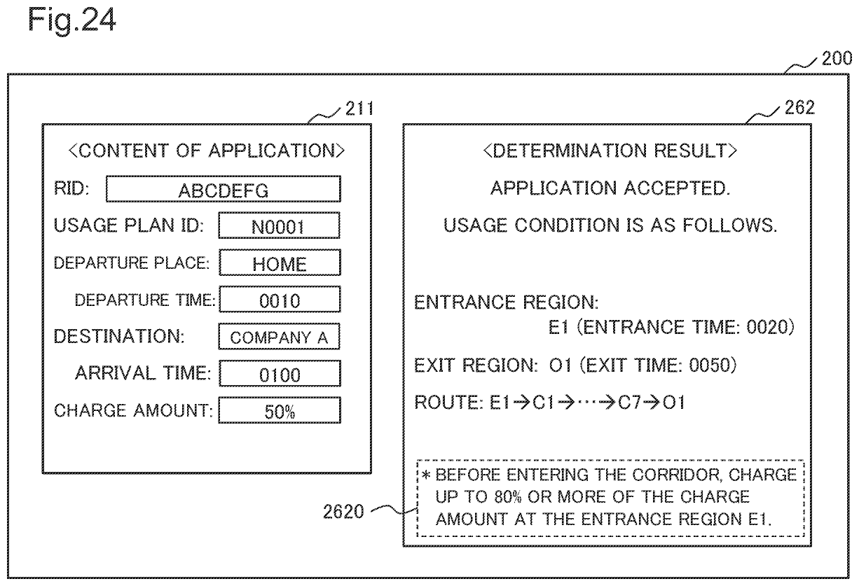

FIG. 24 illustrates an example in which the determination information (determination information 262) based on the reservation information 232 in FIG. 23 is displayed on the screen of the terminal device 200. In FIG. 24, the usage plan application 211 is displayed side by side with the determination information 262. FIG. 24 illustrates the determination information 261 in a case where use of the corridor is permitted. The determination information 262 includes a determination result “application accepted”. In addition, the determination information 262 includes usage conditions such as a time of entering the corridor via the entrance region E1 (entrance time), a time of exiting from the corridor via the exit region O7 (exit time), and a route. Furthermore, caution information 2620 indicating “Before entering the corridor, charge up to 80% or more of the charge amount at the entrance region E1.” is displayed in the determination information 262. The user who has confirmed the determination result can know the cautionary note (charging) at the time of using the corridor by checking the caution information 2620. The user who has confirmed the determination result can use the corridor according to the usage condition and the cautionary note.

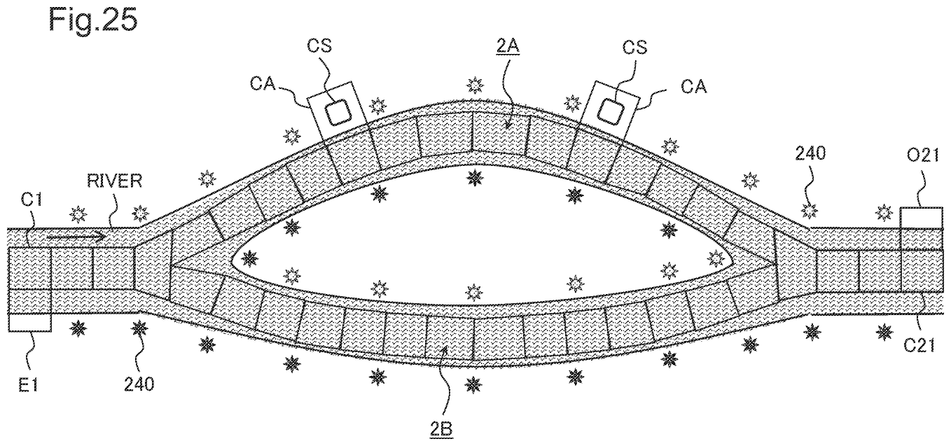

FIG. 25 illustrates an example in which the corridor branches into two between the entrance region E1 and the exit region O21 of the corridor desired to be used. Two charging areas CA are arranged in the corridor 2A among the corridors branched into two. The charging station CS is arranged in the charging area CA. On the other hand, the charging area CA is not arranged in the corridor 2B.

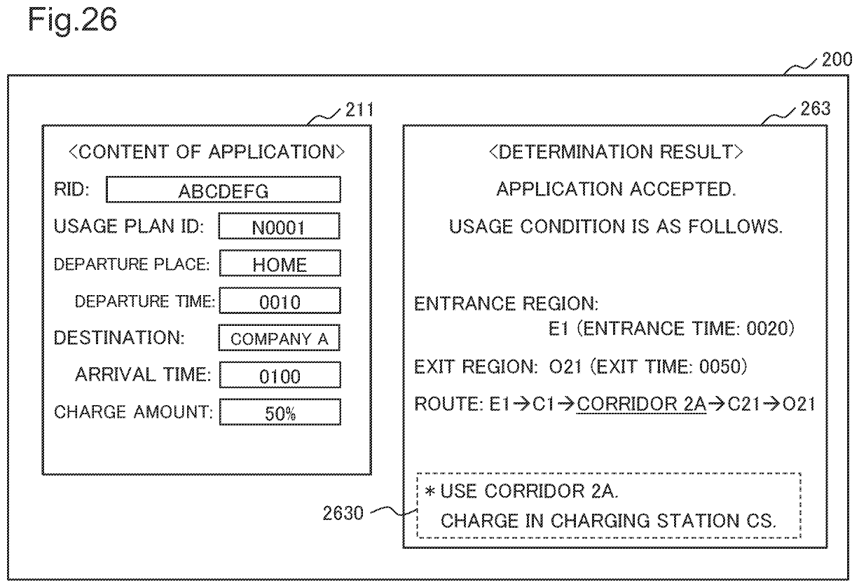

FIG. 26 is an example of displaying the determination information (the determination information 263) corresponding to the usage plan application 211 on the screen of the terminal device 200. In FIG. 26, the usage plan application 211 is displayed side by side with the determination information 263. FIG. 26 illustrates the determination information 263 in a case where use of the corridor is permitted. The determination information 263 includes a determination result “application accepted”. In addition, the determination information 263 includes usage conditions such as a time of entering the corridor via the entrance region E1 (entrance time), a time of exiting from the corridor via the exit region O7 (exit time), and a route. The route includes a corridor (corridor 2A) to be advanced. Furthermore, in the determination information 263, caution information 2630 “Please use the corridor 2A. Charge at the charging station CS” is displayed. The user who has confirmed the determination result can know the cautionary note (charging) at the time of using the corridor by checking the caution information 2630. The user who has confirmed the determination result can use the corridor according to the usage condition and the cautionary note.

### (Operation)

Next, the operation of the determination device 20 will be described with reference to the drawings. Hereinafter, a flowchart relating to an operation example of the determination device 20 at the normal time will be described. An operation example of the determination device 20 at the time of emergency conforms to the first example embodiment (FIG. 17). The following flowchart summarizes the flow of operations of the determination device 20, and detailed operations and processes are omitted. The detailed operations and processes of the determination device 20 are as described above.

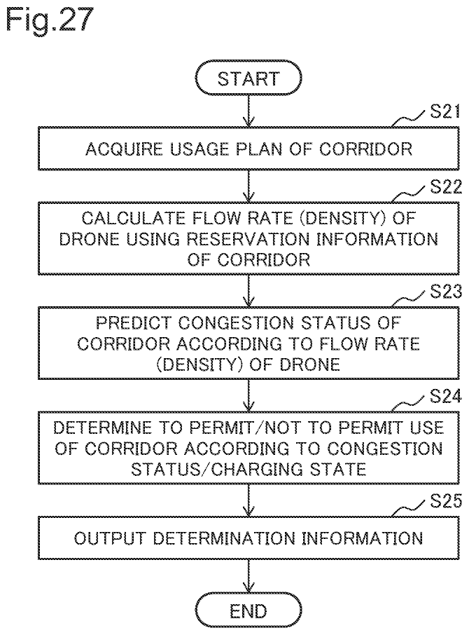

FIG. 27 is a flowchart relating to an operation example of the determination device 20 at the normal time. In the description along the flowchart of FIG. 27, the determination device 20 will be described as an operation subject.

In FIG. 27, first, the determination device 20 acquires a usage plan of a corridor (step S21).

Next, the determination device 20 calculates the flow rate of the drone in the corridor when the usage plan is accepted, using the reservation information of the corridor (step S22).

Next, the determination device 20 predicts a congestion status of the corridor when the usage plan is accepted according to the calculated flow rate of the drone (step S23).

Next, the determination device 20 determines to permit/not to permit the use of the corridor according to the congestion status predicted for the corridor when the usage plan is accepted and the charging state of the drone 270 for which the usage plan is being applied (step S24).

Next, the determination device 20 outputs determination information including a determination result (step S25).

As described above, the determination device of the present example embodiment includes the usage plan acquisition unit, the calculation unit, the storage unit, the prediction unit, the determination unit, and the output unit. The usage plan acquisition unit acquires a usage plan of a corridor formed for navigation of the drone. In addition, the usage plan acquisition unit acquires a usage plan including the charge amount of the drone for which the use of the corridor is planned. The storage unit stores reservation information of the corridor and information regarding a charging station that can be used when using the corridor. The calculation unit refers to the reservation information and calculates a determination parameter relating to congestion in the corridor corresponding to the usage plan. The prediction unit predicts a congestion status of the corridor according to the calculated determination parameter. The determination unit generates determination information including a determination result relating to availability of the corridor and a usage condition of the corridor according to the predicted congestion status of the corridor and the charge amount of the drone included in the usage plan. For example, in a case where the charge amount of the drone included in the usage plan is insufficient, the determination unit generates caution information regarding the use of the corridor in accordance with the reservation status of the charging station included in the reservation information. The output unit outputs determination information relating to the use of the corridor.

According to the present aspect, since the determination is made including the charge amount of the drone with respect to the applied usage plan, it is possible to prevent the drone using the corridor from crashing due to the runout of the charge.

### Third Example Embodiment

Next, a determination device according to a third example embodiment will be described with reference to the drawings. The determination device of the present example embodiment determines availability of a corridor based on environment information of the corridor in addition to the reservation information of a route (also referred to as a corridor) through which the drone navigates. In the present example embodiment, a corridor and a drone are similar to those in the first example embodiment. The method of the present example embodiment can also be applied to the second example embodiment.

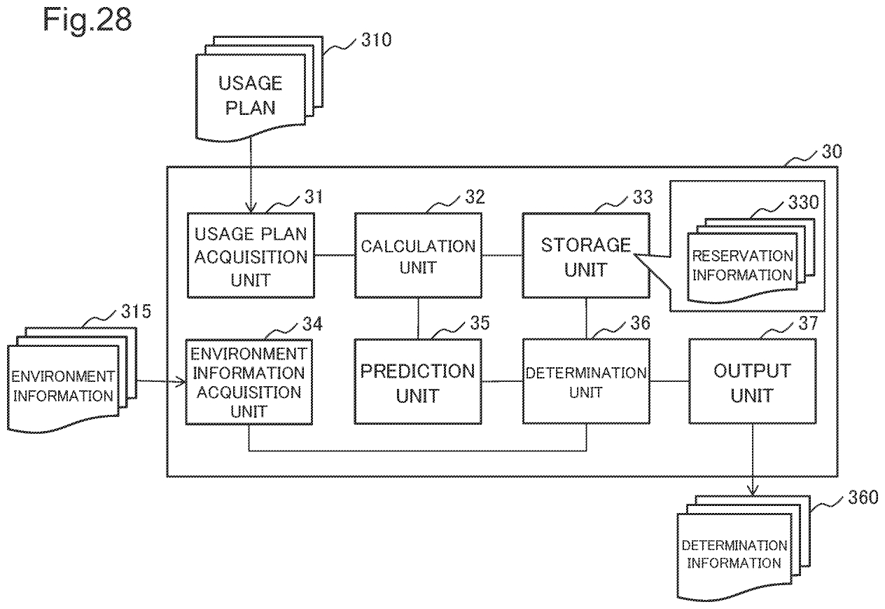

FIG. 28 is a block diagram illustrating an example of a configuration of a determination device 30 according to the present example embodiment. The determination device 30 includes a usage plan acquisition unit 31, a calculation unit 32, a storage unit 33, an environment information acquisition unit 34, a prediction unit 35, a determination unit 36, and an output unit 37. FIG. 28 illustrates the usage plan 310 input to the usage plan acquisition unit 31, the environment information 315 input to the environment information acquisition unit 34, and the determination information 360 output from the output unit 37.

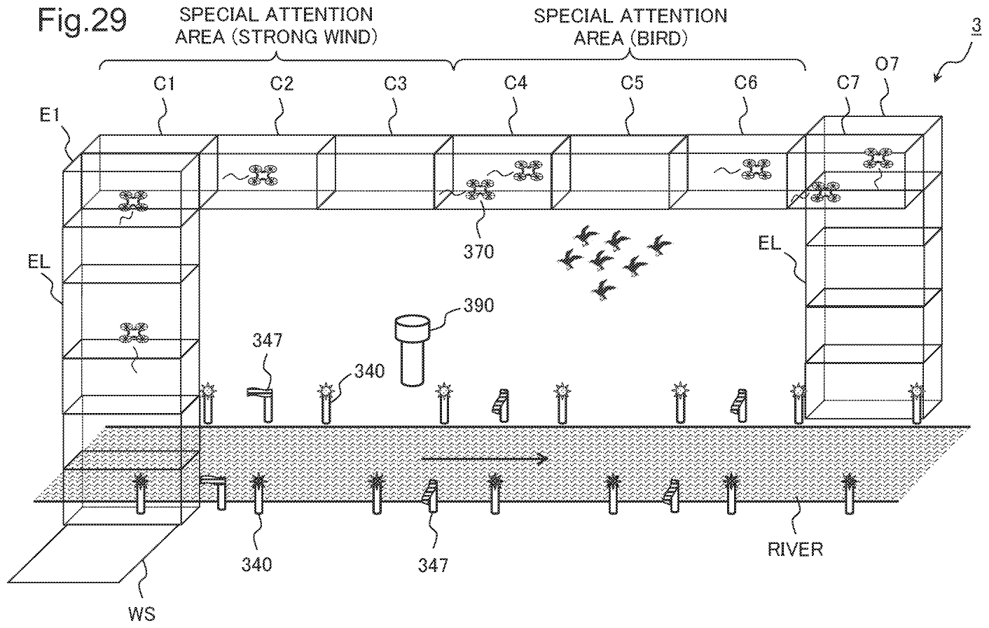

FIG. 29 is a conceptual diagram illustrating an example of a corridor 3 formed above a river. FIG. 29 illustrates a state in which a plurality of drones 470 navigate the inside of the corridor 3. The corridor 3 of the present example embodiment is similar to the corridor 1 of the first example embodiment.

The position where the corridor 3 is formed is defined by a plurality of guide lamps 340 arranged on both banks of the river. The arrangement and light emission of the guide lamp 340 are similar to those in the first example embodiment. The advancing direction inside the corridor 3 is a direction from the left to the right in the plane of drawing of FIG. 29. For example, the drone 370 navigates inside the corridor 3 according to the light emitting color of the guide lamp 340 included in the image of the lower side captured by the camera.

FIG. 29 illustrates a waiting space WS, an up/down route EL, a corridor region C, an entrance region E1, and an exit region O7. The waiting space WS, the up/down route EL, the corridor region C, the entrance region E1, and the exit region O7 are similar to those in the first example embodiment. In the present example embodiment, an anemometer 347 is installed on both banks of a river. FIG. 29 illustrates an anemometer 347 having a streamer. The anemometer 347 is not particularly limited as long as it can measure the direction and strength of the wind. In the case of the example of FIG. 29, the wind direction and the wind volume can be measured based on the direction and angle of the stream of the anemometer 347. For example, the anemometer 347 may be a measuring instrument that outputs the measured wind direction and wind force as digital data.

A management tower 390 is disposed beside the river. The management tower 390 has a communication function and a camera. The management tower 390 receives a signal transmitted from the drone 370 navigating inside the corridor 3. In addition, the management tower 390 captures the image of the drone 370 using the corridor 3. Furthermore, the management tower 390 acquires information (also referred to as environment information 315) relating to the environments such as an airspace, a river, and a coast where the corridor 3 is formed, and surroundings thereof. The environment information 315 is used by the determination device 30 to determine availability of the corridor 3.

For example, the management tower 390 captures an image of an airspace or a river where the corridor 3 is formed, a coast, a periphery thereof, and the like, and acquires the captured image as the environment information 315. For example, the management tower 390 acquires data regarding the wind direction and the wind force measured by the anemometer 347 as the environment information 315. For example, the management tower 390 acquires weather information of a district where the corridor 3 is formed as the environment information 315. For example, the management tower 390 may acquire weather information from a weather observation device (not illustrated) installed in a district or an airspace where the corridor 3 is formed. For example, the weather observation device includes at least one of measuring instruments such as an anemometer, a thermometer and hygrometer, a pluviometer, a pyranometer, a rain gauge, a snow depth gauge, a barometer, a soil moisture gauge, and a water level gauge. For example, the management tower 390 acquires data such as wind direction, wind force, temperature, humidity, rainfall, solar radiation amount, presence or absence of rainfall, snow depth, atmospheric pressure, a moisture content in soil, and a water level measured by a weather observation device installed in a district or an airspace where the corridor 3 is formed as the environment information 315. For example, the weather observation device is installed on the ground or in the ground in the vicinity of the corridor 3, or at the edge of the water or under water of a river. For example, the weather observation device may be installed in an airspace inside and outside the region of the corridor 3 by a balloon or the like. Furthermore, the weather observation device may be installed in a drone 370 for weather observation that navigates the corridor 3. The observation target and form of the weather observation device are not particularly limited.

The management tower 390 transmits transmitted information and images included in signals transmitted from the plurality of drones 370, the environment information 315 acquired by the management tower 390, and the like to a management device (not illustrated) that manages the corridor 3. The management device is connected to the determination device 30. When the environment information 315 is weather information, the environment information 315 may be acquired by the management device or the determination device 30 without going through the management tower 390. The transmitted information and the environment information 315 transmitted from the management tower 390 are used for managing the drone 370 using the corridor 3. For example, any of the plurality of guide lamps 340 arranged on both banks of the river may have the function of the management tower 390.

In the example of FIG. 29, the streamer from the anemometer 347 on the lower side of the corridor region C2 flows in the left direction (upstream direction). For example, when an image captured by the management tower 390 is analyzed, it is estimated that a strong wind is blowing or that there is a possibility that a strong wind will blow in the vicinity of the corridor region C2 because a strong wind is blowing on the lower side of the corridor region C2. In addition, birds flock in airspaces near the corridor region C5. For example, when an image captured by the management tower 390 is analyzed, it is estimated that there is a possibility a flock of birds may enter the corridor region C5.

The usage plan acquisition unit 31 has a configuration similar to that of the usage plan acquisition unit 11 of the first example embodiment. The usage plan acquisition unit 31 acquires the usage plan 310 of the corridor. The usage plan 310 is input by a user who wishes to use the corridor. The usage plan 310 is similar to the usage plans of the first and second example embodiments. The usage plan acquisition unit 31 outputs information included in the acquired usage plan 310 to the calculation unit 32.

The storage unit 33 has the same configuration as the storage unit 13 of the first example embodiment. The storage unit 33 stores the reservation information 330 of the corridor. The reservation information 330 includes information such as the number of drones 370 for which the corridor is being reserved (number of drones that made the reservation), the number of drones 370 that can use the corridor (upper limit number of drones), and the flow rate (density). The reservation information 330 is similar to the reservation information of the first and second example embodiments.

The calculation unit 32 has the same configuration as the calculation unit 12 of the first example embodiment. The calculation unit 32 acquires the usage plan 310 from the usage plan acquisition unit 31. In addition, the calculation unit 32 acquires the reservation information 330 of the corridor corresponding to the usage plan 310 from the storage unit 33.

The calculation unit 32 calculates a determination parameter in a case where the application for the usage plan 310 is accepted based on the reservation information 330 of the corridor. The calculation unit 32 calculates a determination parameter regarding a planned time zone included in the usage plan 310. For example, the calculation unit 32 calculates, as the determination parameter, the flow rate (density) of the drone 370 in the corridor in the planned time zone and the number of drones that can make a reservation in a case where the application for the usage plan is accepted. The calculation unit 32 outputs the calculated determination parameter to the prediction unit 35.

The prediction unit 35 has the same configuration as the prediction unit 15 of the first example embodiment. The prediction unit 35 predicts a congestion status of the corridor in the applied planned time zone using the determination parameter calculated by the calculation unit 32. The prediction unit 35 outputs the prediction result of the congestion status of the corridor to the determination unit 36.

The environment information acquisition unit 34 acquires the environment information 315. The environment information acquisition unit 34 outputs the acquired environment information 315 to the determination unit 36.

The determination unit 36 determines whether to permit/not to permit the use of the corridor in accordance with the congestion status predicted by the prediction unit 35 and the environment information 315 around the corridor 3. Furthermore, the determination unit 36 may determine to permit/not to permit the use of the corridor with reference to the charge amount included in the usage plan 310.

For example, the determination unit 36 generates determination result and caution information based on the environment information 315 such as the wind direction and the wind force measured by the anemometer 347. In the example of FIG. 29, the streamer from the anemometer 347 on the lower side of the corridor region C2 flows in the left direction (upstream direction). There is a possibility that a strong wind blows around the corridor region C2. In such a case, for example, the determination unit 36 generates caution information requesting navigation with reduced speed in the regions of the corridor regions C1 to C3. For example, when the wind volume measured in the vicinity of any of the corridor regions C exceeds a predetermined threshold value, the determination unit 36 may generate a determination result to prohibit the navigation around the relevant corridor region C.

For example, the determination unit 36 generates a determination result and caution information based on an analysis result of the environment information 315 such as an image captured by the management tower 390. In the example of FIG. 29, birds flock in an airspace in the vicinity of the corridor region C5. A flock of birds may enter the corridor region C5. In such a case, for example, the determination unit 36 requests that the corridor regions C4 to C6 have a possibility of bird strike. In a case of being based on the analysis result of the image captured by the management tower 390, it merely needs to be configured such that caution is advised according to observation of not only a flock of birds but also any flying object, animal, or the like that may become an obstacle. For example, in a case where an obstacle is observed in the vicinity of any of the corridor regions C, the determination unit 36 may generate a determination result to prohibit the navigation around the corridor region C.

When the environment information 315 is used, it may be better to change the determination information 360 corresponding to the usage plan 310 according to the change in the environment. In such a case, even when the use of the corridor 3 is permitted according to the usage plan 310, it may be arranged to issue a notification for changing the use of the corridor 3 to non-permitting to the user.

The output unit 37 outputs the determination information 360 generated by the determination unit 36. For example, the determination information 360 output from the output unit 37 is output to the terminal device 300. The determination information 360 is displayed on the screen of the terminal device 300. For example, the determination information 360 output from the output unit 37 may be output to another system (not illustrated). The purpose of the determination information 360 output from the output unit 37 is not particularly limited.

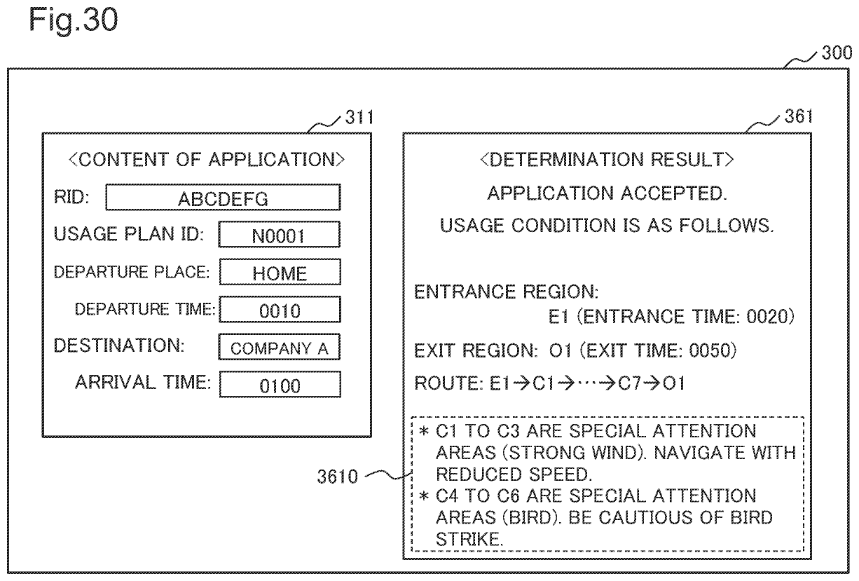

FIG. 30 illustrates an example in which the determination information (determination information 361) based on the environment status in FIG. 29 is displayed on the screen of the terminal device 300. In FIG. 30, the usage plan application 311 is displayed side by side with the determination information 361. FIG. 30 illustrates the determination information 361 in a case where use of the corridor is permitted. The determination information 361 includes a determination result “application accepted”. In addition, caution information 3610 at the time of applying for use of the corridor is displayed in the determination information 361. In the example of FIG. 30, caution information 3610 “C1 to C3 are special attention areas (strong winds). Please navigate with reduced speed. C4 to C6 are special attention areas (birds). Please be aware of bird strike” is displayed. The user who has confirmed the determination result can know the cautionary note at the time of applying for the use of the corridor by checking the caution information 3610.

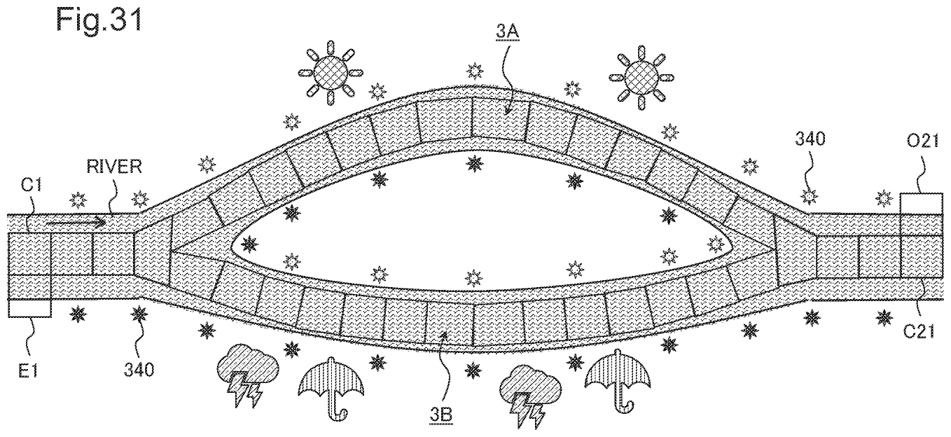

FIG. 31 illustrates an example in which the corridor branches into two between the entrance region E1 and the exit region O21 of the corridor desired to be used. Of the corridors branched into two, the weather in the corridor 3A is sunny. On the other hand, the weather in the corridor 3B is thunderstorm. In such a case, it is preferable to avoid using the corridor 3B which is the thunderstorm and use the corridor 3A which is sunny. For example, the weather around the corridor may be estimated based on a weather forecast or may be estimated based on the current weather.

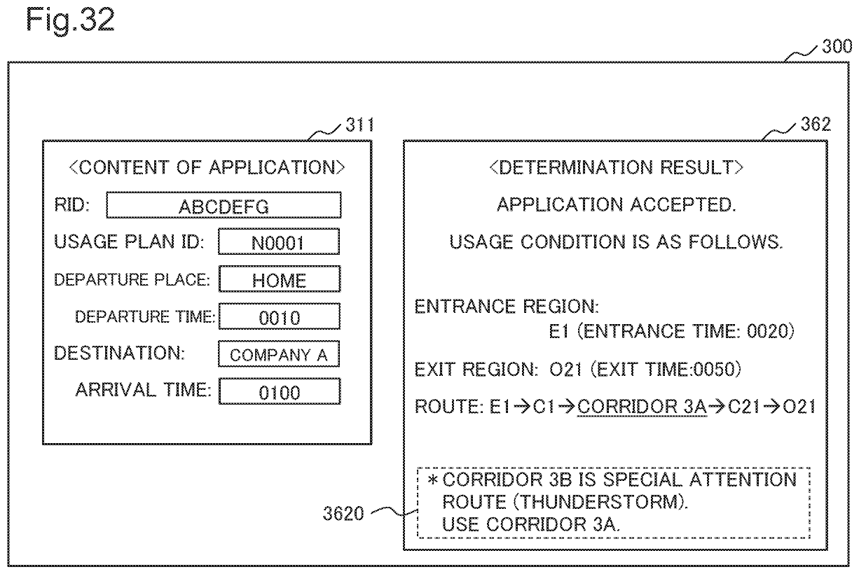

FIG. 32 illustrates an example in which the determination information (determination information 362) based on the environment status in FIG. 31 is displayed on the screen of the terminal device 300. In FIG. 32, the usage plan application 311 is displayed side by side with the determination information 362. FIG. 32 illustrates the determination information 362 in a case where use of the corridor is permitted. The determination information 362 includes a determination result “application accepted”. In addition, caution information 3620 at the time of applying for use of the corridor is displayed in the determination information 362. In the example of FIG. 32, caution information 3620 “The corridor 3B is a special attention route (thunderstorm). Please use the corridor 3A” is displayed. The caution information 3620 includes a usage condition “Please use the corridor 3A”. The user who has checked the determination result can use the corridor according to the usage condition included in the caution information 3620.

### (Operation)

Next, the operation of the determination device 30 will be described with reference to the drawings. Hereinafter, a flowchart relating to an operation example of the determination device 30 at the normal time will be described. An operation example of the determination device 30 at the time of emergency conforms to the first example embodiment (FIG. 17). The following flowchart summarizes the flow of operations of the determination device 30, and detailed operations and processes are omitted. The detailed operations and processes of the determination device 30 are as described above.

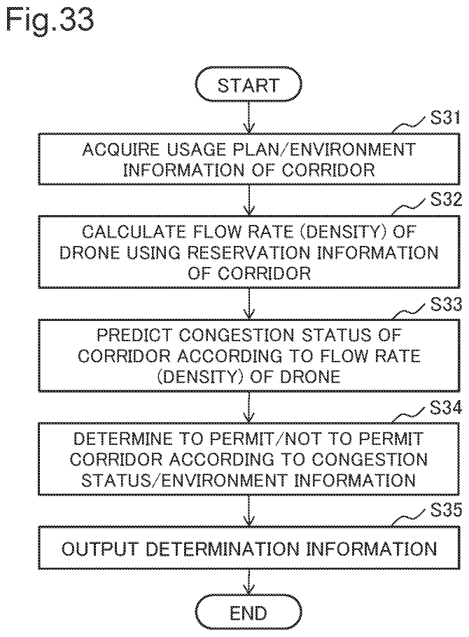

FIG. 33 is a flowchart relating to an operation example of the determination device 30 at the normal time. In the description along the flowchart of FIG. 33, the determination device 30 will be described as an operation subject.

In FIG. 33, first, the determination device 30 acquires the usage plan/environment information of the corridor (step S31).

Next, the determination device 30 calculates the flow rate of the drone in the corridor when the usage plan is accepted, using the reservation information of the corridor (step S32).

Next, the determination device 30 predicts a congestion status of the corridor when the usage plan is accepted according to the calculated flow rate of the drone (step S33).

Next, the determination device 30 determines to permit/not to permit the use of the corridor according to the congestion status predicted for the corridor when the usage plan is accepted and the environment information of the corridor (step S34).

Next, the determination device 30 outputs determination information including a determination result (step S35).

As described above, the determination device of the present example embodiment includes the usage plan acquisition unit, the environment information acquisition unit, the calculation unit, the storage unit, the prediction unit, the determination unit, and the output unit. The usage plan acquisition unit acquires a usage plan of a corridor formed for navigation of the drone. The environment information acquisition unit acquires environment information of the corridor. The storage unit stores the reservation information of the corridor. The calculation unit refers to the reservation information and calculates a determination parameter relating to congestion in the corridor corresponding to the usage plan. The prediction unit predicts a congestion status of the corridor according to the calculated determination parameter. The determination unit generates determination information including a determination result regarding availability of the corridor and a usage condition of the corridor according to the predicted congestion status of the corridor. For example, the determination unit determines availability of the corridor according to the status of the corridor included in the environment information. The output unit outputs determination information relating to the use of the corridor.

According to the present aspect, since the availability of the corridor is determined in accordance with the environment information of the corridor, the corridor can be used more safely.

### Fourth Example Embodiment

Next, a management system according to a fourth example embodiment will be described with reference to the drawings. The management system of the present example embodiment includes the determination devices of the first to third example embodiments. A management system according to the present example embodiment manages navigation of a drone in a use determination target corridor by a determination device.

### (Configuration)

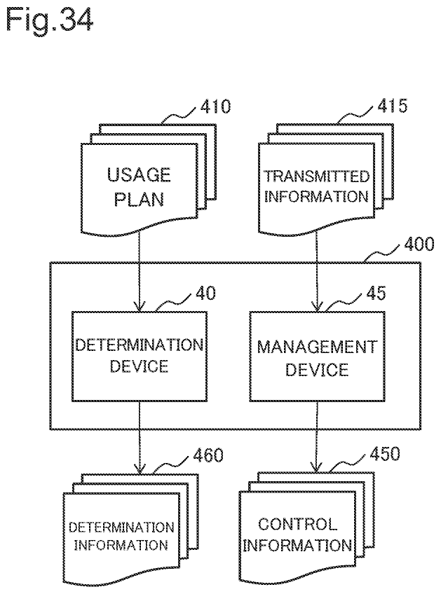

FIG. 34 is a block diagram illustrating an example of a configuration of a management system 400 according to the present example embodiment. The management system 400 includes a determination device 40 and a management device 45. The determination device 40 is any of the determination devices of the first to third example embodiments. FIG. 34 illustrates the usage plan 410 input to the determination device 40 and the determination information 460 output from the determination device 40. FIG. 34 illustrates transmitted information 415 input to the management device 45 and control information 450 output from the management device 45. The usage plan 410 and the determination information 460 are as described in the first to third example embodiments. The transmitted information 415 and the control information 450 will be described later.

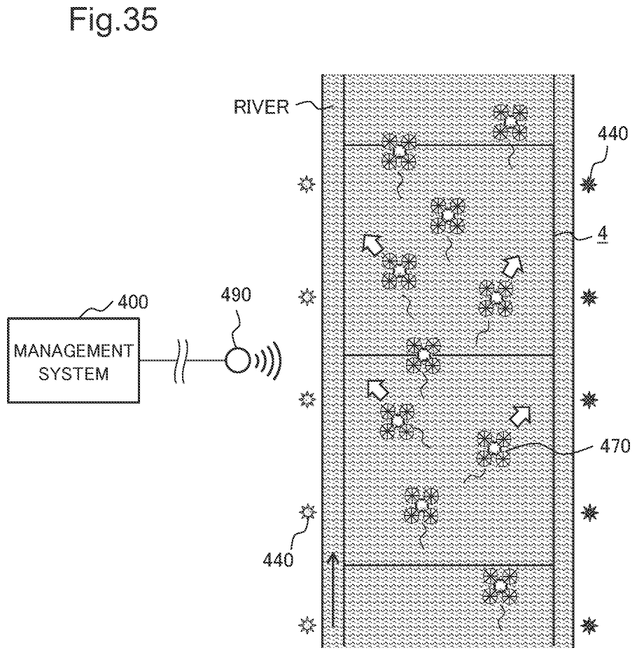

FIG. 35 is a conceptual view of a corridor 4 formed above a river as viewed from above. FIG. 35 illustrates a state in which a plurality of drones 470 navigate the inside of the corridor 4. The corridor 4 of the present example embodiment is similar to the corridor 1 of the first example embodiment. In FIG. 35, the river flows from the lower side (upstream) to the upper side (downstream).

The position where the corridor 4 is formed is defined by a plurality of guide lamps 440 arranged on both banks of the river. The arrangement and light emission of the guide lamp 440 are similar to those in the first example embodiment. The advancing direction inside the corridor 4 is a direction from the bottom to the top in the plane of drawing of FIG. 35. For example, the drone 470 navigates inside the corridor 4 according to the light emitting color of the guide lamp 440 included in the image of the lower side captured by the camera.

A management tower 490 is disposed beside the river. The management tower 490 has the same configuration as any of the management towers of the first to third example embodiments. The management tower 490 has a communication function and a camera. The management tower 490 receives a signal transmitted from the drone 470 navigating inside the corridor 4. The signal transmitted from the drone 470 includes transmitted information including the RID of the drone 470. The RID includes position information of the drone 470. In addition, the management tower 490 captures an image of the drone 470 using the corridor 4. Furthermore, the management tower 490 may acquire environment information of an airspace or a river where the corridor 4 is formed, a coast, a periphery thereof, and the like.

The management tower 490 transmits transmitted information and images included in signals transmitted from the plurality of drones 470, environment information acquired by the management tower 490, and the like to the management device 45 that manages the corridor 4. The management device is connected to the determination device 30. The transmitted information and the environment information transmitted from the management tower 490 are used for managing the drone 470 using the corridor 4. For example, any of the plurality of guide lamps 440 arranged on both banks of the river may have the function of the management tower 490.

In addition, the management tower 490 acquires control information of the drone 470 generated by the management device 45. The management tower 490 transmits the control information acquired from the management device 45 to the plurality of drones 470 navigating inside the corridor 4. The plurality of drones 470 located inside or around the corridor 4 navigates inside the corridor 4 in accordance with control information transmitted from the management tower 490.

### [Management Device]

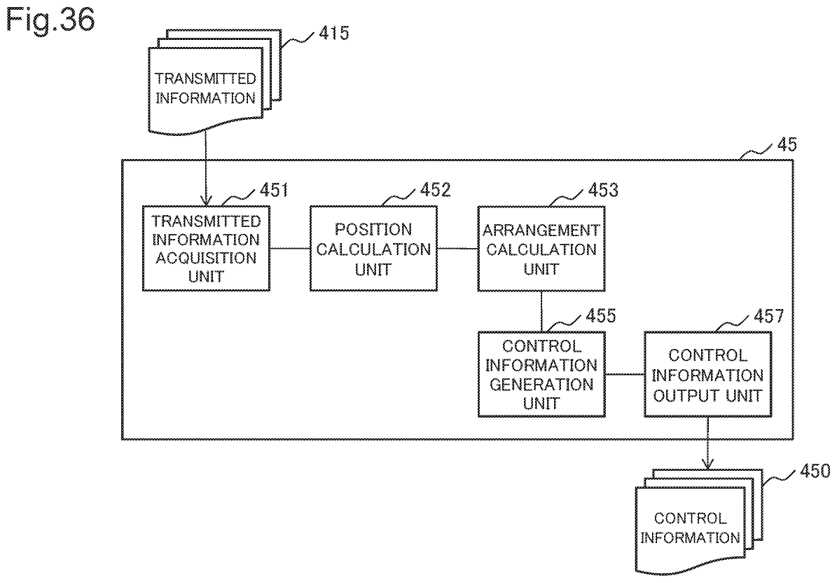

FIG. 36 is a block diagram illustrating an example of a configuration of the management device 45. The management device 45 includes a transmitted information acquisition unit 451, a position calculation unit 452, an arrangement calculation unit 453, a control information generation unit 455, and a control information output unit 457.

The transmitted information acquisition unit 451 acquires transmitted information of a plurality of drones 470 using the corridor 4 from the management tower 490 arranged in the vicinity of the corridor 4. The transmitted information acquisition unit 451 extracts the RID included in the transmitted information. The transmitted information acquisition unit 451 outputs the extracted RID to the position calculation unit 452. The use of information other than the RID is not particularly limited.

The position calculation unit 452 acquires the RIDs of the plurality of drones 470 using the corridor 4 from the transmitted information acquisition unit 451. The position calculation unit 452 calculates the positions of the plurality of drones 470 using the position information included in the acquired RID. For example, the position calculation unit 452 calculates the positions of the plurality of drones 470 at the transmission time of the RID. For example, the position calculation unit 452 calculates the positions of the plurality of drones 470 at a time point after a predetermined time has elapsed from the transmission time of the RID. For example, the position calculation unit 452 calculates the positions of the plurality of drones 470 at the time when the control information 465 generated based on the transmission time of the RID is received by the plurality of drones 470 navigating the corridor 4. For example, the position calculation unit 452 calculates the positions of the plurality of drones 470 at the time when the control information 465 is received based on the changes and speeds of the positions of the plurality of drones 470 calculated so far. The position calculation unit 452 outputs the calculated positions of the plurality of drones 470 to the arrangement calculation unit 453.

The arrangement calculation unit 453 acquires the positions of the plurality of drones 470 calculated by the position calculation unit 452. The arrangement calculation unit 453 calculates the arrangement of the plurality of drones 470 inside the corridor 4 based on the acquired position relationship of the plurality of drones 470. For example, the arrangement calculation unit 453 calculates the number of drones 470 located in a unit region inside the corridor 4. For example, the unit region is set two-dimensionally, such as 10 square meters (m²). For example, the unit region is set three-dimensionally, such as 10 cubic meters (m³). In that case, the flight altitude measured using a barometer or the like mounted on the drone 470 may be used. The arrangement calculation unit 453 outputs the calculated number of drones 470 located in the unit region to the control information generation unit 455.

The control information generation unit 455 acquires the number of drones 470 located in the unit region calculated by the arrangement calculation unit 453. The control information generation unit 455 generates the control information 465 for each drone 470 according to the acquired number of drones 470 located in the unit region. The control information 465 is information for controlling the directions and speeds of the plurality of drones 470. In a case where the number of the drones 470 in the unit region exceeds the upper limit number of drones set in the unit region, the control information generation unit 455 generates the control information 465 for performing control in such a way as to move the positions of the drones 470 away from each other. In a case where the number of drones 470 in the unit region does not exceed the upper limit number of drones set in the unit region, the control information generation unit 455 does not generate the control information 465 of those drones 470. For example, in a case where the number of drones 470 in the unit region does not exceed the upper limit number of drones set in the unit region, the control information 465 may be generated to perform control in such a way that the positions of the drones 470 do not to approach each other.

The control information generation unit 455 may generate the control information 465 of the plurality of drones 470 using a machine learning method. For example, a model that outputs control information 465 for arranging a plurality of drones 470 in an appropriate position relationship is generated in response to an input of position information of a plurality of drones 470 navigating the inside of the corridor 4. Calculation by the arrangement calculation unit 453 can be omitted by using such a model. Description on the details of the model that outputs the control information 465 according to the input of the position information of the plurality of drones 470 will be omitted.

The control information output unit 457 outputs the control information 465 generated by the control information generation unit 455 to the management tower 490. In a case where the management system 400 is arranged in the vicinity of the corridor 4, the management system 400 may be configured to transmit the control information to the drone 470 navigating the corridor 4. For example, the management device 45 may be disposed in the management tower 490 or the guide lamp 440.

FIG. 35 illustrates a state in which control information 465 is transmitted from the management tower 490 to a plurality of drones 470 navigating the corridor 4. The drone 470 to be controlled changes the direction and speed according to the control information transmitted from the management tower 490. In FIG. 35, a state in which some of the plurality of drones 470 changes the advancing direction in accordance with the control information 465 is indicated by an arrow. The load in the generation and communication of the control information 465 can be reduced in the configuration in which the control information 465 is transmitted to the drone 470 to be controlled rather than the configuration in which the control information 465 is transmitted to all of the plurality of drones 470.

### [Drone]

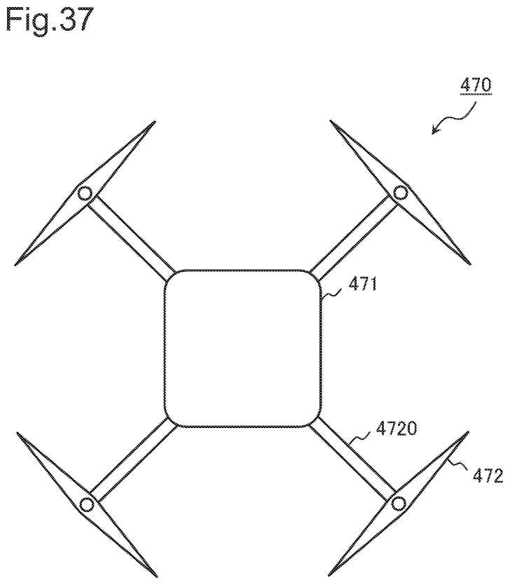

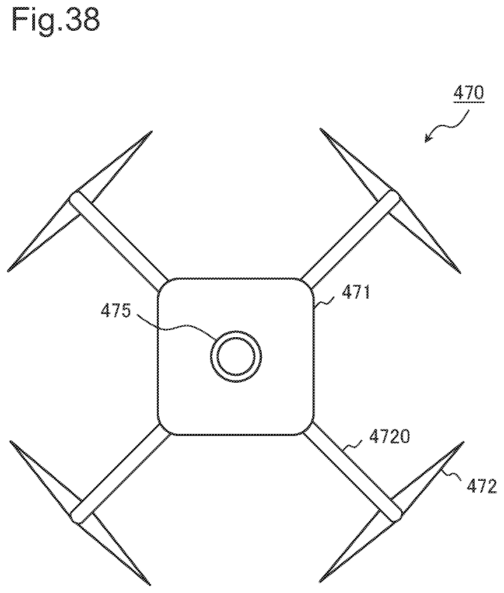

Next, an example of the drone 470 using the corridor 4 will be described with reference to the drawings. FIGS. 37 to 38 are conceptual diagrams of an example of the drone 470. FIG. 37 is a plan view of the drone 470. FIG. 38 is a bottom view of the drone 470. Note that a side view, a rear view, a slope view, and the like of the drone 470 are omitted. The drones of the first to third example embodiments also have the same structure as the drone 470 of FIGS. 37 to 38.

The drone 470 has a main body 471, a propeller 472, and a camera 475. FIG. 38 illustrates a lens portion of the camera 475. In addition, the drone 470 has a function of carrying a load. For example, the drone 470 carries a load by storing the load inside the main body 471, hanging the load from the main body 471, or placing the load on the main body 471. In a case where the load is hung from the main body 471, the camera 475 may be attachable under the load in order to capture an image of the lower side of the drone 470.

The camera 475 captures an image of the periphery of the drone 470. In the case of FIG. 38, the camera 475 captures an image of the lower side of the drone 470. A plurality of cameras 475 may be mounted on the drone 470 in order to capture an image of the side and the upper side of the drone 470. For example, the camera 475 may be arranged in such a way as to be able to capture images in multiple directions by changing the aerial posture of the drone 470. Furthermore, the lens of the camera 475 may be provided with a protective member such as a protective film or a protective glass.

The drone 470 includes at least one propeller 472 for causing the main body 471 to fly. The propeller 472 is also called a rotor or a rotary wing. The propeller 472 is fixed to the main body 471 by an arm 4720. Each propeller 472 includes a blade that floats the main body 471 by rotating, and a motor for rotating the blade. The size and attachment position of the propeller 472 in FIGS. 37 to 38 are not sufficiently designed for flying the drone 470 and are conceptual.

In the examples of FIGS. 37 to 38, four propellers 472 are installed on the main body 471 of the drone 470. The rotation number of the plurality of propellers 472 are controlled independently of each other.

FIGS. 37 to 38 illustrate quadcopters with four propellers 472 as an example. The drone 470 may include a single propeller 472 or may be a multicopter including a plurality of propellers 472. Considering the posture stability in the air and the flight performance, the drone 470 is preferably a multicopter including a plurality of propellers 472. When the plurality of propellers 472 are provided in the drone 470, the sizes of the blades of the respective propellers 472 may be different. Furthermore, the rotating surfaces of the blades of the plurality of propellers 472 may be different from each other.

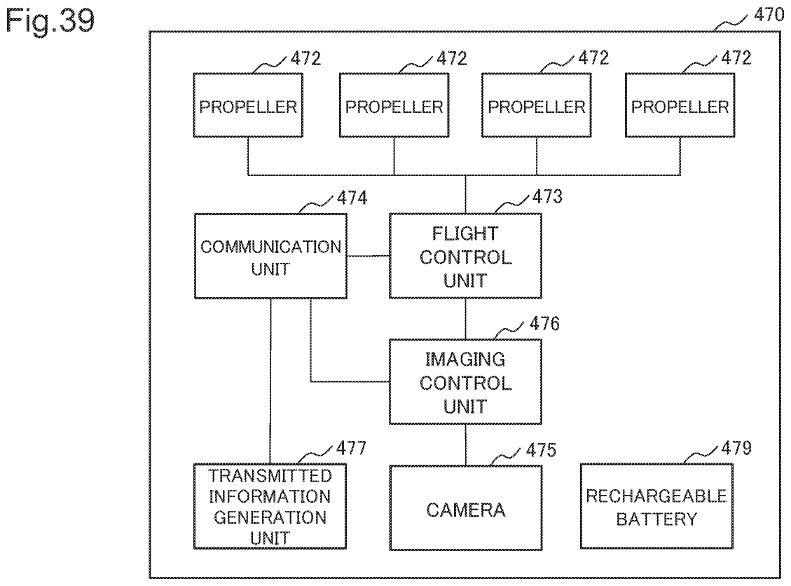

FIG. 39 is a block diagram for explaining a functional configuration of the drone 470. The drone 470 includes main body 471 (not illustrated in FIG. 39), at least one propeller 472, a flight control unit 473, a communication unit 474, a camera 475, an imaging control unit 476, a transmitted information generation unit 477, and a rechargeable battery 479. Since the propeller 472 has been described above, description thereof will be omitted.

The communication unit 474 receives a radio signal including control information transmitted from the management tower 490. The radio signal acquired by the communication unit 474 is not limited to the control information. Furthermore, the communication unit 474 transmits a signal including transmitted information generated by the transmitted information generation unit 477 and an image captured by the camera 475. The transmitted information includes registration information, manufacturing number, position information, time, authentication information, and the like of each drone 470. The registration information, the manufacturing number, the authentication information, and the like of the drone 470 are information that do not change during use of the corridor 4 (also referred to as invariable information). The position information and the time are information that are updated as needed (also referred to as variation information). For example, the communication unit 474 transmits a signal at a transmission cycle of one or more times per second by a communication method such as Bluetooth (registered trademark).

The flight control unit 473 is a means for controlling the flight of the drone 470. The flight control unit 473 controls the rotation of the at least one propeller 472. The flight control unit 473 navigates the drone 470 by controlling the rotation of the propeller 472 according to a preset navigation route. For example, the rotation number for each propeller 472 is controlled by performing the drive control of the motor for each propeller 472. For example, the flight control unit 473 may control the rotation of the propeller 472 according to flight conditions in which the operations performed by the drone 470 are summarized in a table form or the like. The preset navigation route and flight conditions may be stored in a storage unit (not illustrated).

The flight control unit 473 controls the rotation of the propeller 472 based on of the position of the guide lamp 440 included in the image acquired from the imaging control unit 476 while the drone 470 is navigating inside the corridor 4. The flight control unit 473 controls the rotation of the propeller 472 in such a way that the drone 470 navigates an appropriate position according to the position of the guide lamp 440 that emits light in a color to be referred to. For example, the flight control unit 473 controls the rotation of the propeller 472 in such a way as to maintain a predetermined position relationship with the guide lamp 440. The position relationship with the guide lamp 440 is not particularly limited as long as the drone navigates inside the corridor 4. For example, in a case where the RID transmitted by another drone 470 can be acquired, the flight control unit 473 controls the rotation of the propeller 472 in such a way that the position relationship with another drone 470 becomes appropriate based on the acquired RID. With this control, the plurality of drones 470 can navigate the inside of the corridor 4 while maintaining an appropriate position relationship with each other.

In addition, the flight control unit 473 controls the rotation of the propeller 472 according to the control information acquired by the communication unit 474. For example, the flight control unit 473 may control the propeller 472 according to a program for autonomously controlling the navigation of the drone 470. For example, the flight control unit 473 may control the propeller 472 according to a program for autonomously controlling the navigation of the plurality of drones 470.

The camera 475 is arranged to capture an image of the periphery of the drone 470. The camera 475 captures an image under the control of the imaging control unit 476. The camera 475 outputs captured image data (also referred to as an image) to the communication unit 474. An imaging lens is incorporated in the camera 475. The lens is preferably a zoom lens capable of changing a focal length. The camera 475 is preferably equipped with an autofocus function for automatically focusing. In addition, the camera 475 is preferably equipped with a function applied to a general digital camera, such as a function of preventing camera shake. The description on a specific structure of the camera 475 will be omitted.

The imaging control unit 476 controls imaging of the camera 475. The imaging control unit 476 causes the camera 475 to image at a predetermined timing. The imaging control by the imaging control unit 476 is not particularly limited. The imaging control unit 476 acquires an image captured by the camera 475. The imaging control unit 476 outputs the acquired image data to the flight control unit 473 and the communication unit 474. For example, the imaging control unit 476 may set the imaging conditions of the images output to the flight control unit 473 and the communication unit 474 to mutually different conditions. For example, an imaging condition of an image to be output to the flight control unit 473 is set to a condition under which an image is captured at a high frequency with a resolution low enough to detect the position of the guide lamp 440. For example, the imaging condition of the image output to the communication unit 474 is set to a condition that image is captured at a low frequency with high resolution enough to verify the situation around the drone 470. By setting the imaging conditions in this manner, it is possible to appropriately obtain information required for flight control and information required for verification of the surrounding situation.

The transmitted information generation unit 477 generates transmitted information unique to the drone 470. The transmitted information includes invariable information and variation information. The transmitted information generation unit 477 generates transmitted information including invariable information and variation information at a predetermined cycle. For example, the transmitted information generation unit 477 generates the transmitted information at a predetermined cycle of about once per second. The invariable information includes registration information, a manufacturing number, authentication information, and the like of the drone 470. The invariable information may be stored in a storage unit (not illustrated). The variation information includes position information and time. For example, the transmitted information generation unit 477 generates the position information using data collected by a positioning system such as a global positioning system (GPS). The transmitted information generation unit 477 may acquire the position information of the position measurement device from a position measurement device (not illustrated) installed at the periphery of the corridor 4. In a case where a sensor for specifying a flight position, such as a geomagnetic sensor, an acceleration sensor, a speed sensor, an altitude sensor, or a distance measurement sensor is mounted on the drone 470, the transmitted information generation unit 477 may generate position information by using data collected by these sensors. The transmitted information generation unit 477 outputs the generated transmitted information to the communication unit 474.

The rechargeable battery 479 is a general secondary battery having a charging function. The rechargeable battery 479 is not particularly limited. For example, the rechargeable battery 479 is preferably capable of controlling the charge of the rechargeable battery 479 and monitoring the charge amount of the rechargeable battery 479.

### (Operation)

Next, an operation of the management device 45 will be described with reference to the drawings. The operation of the determination device 40 is as described in any one of the first to third example embodiments. The following flowchart summarizes the flow of operations of the management device 45, and detailed operations and processes will be omitted. The detailed operations and processes of the management device 45 are as described above.

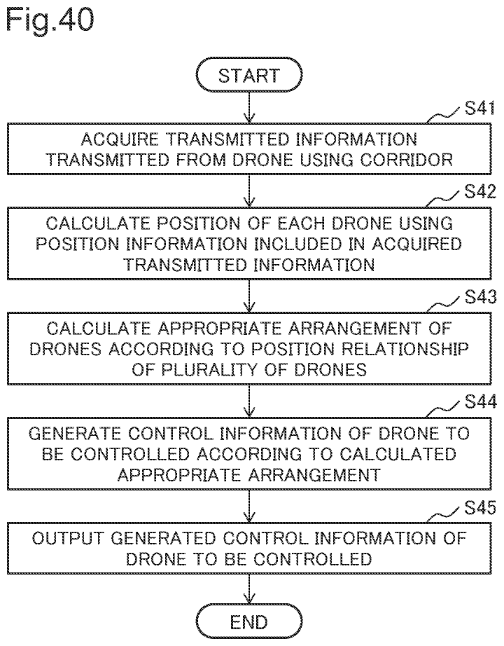

FIG. 40 is a flowchart regarding an operation example of the management device 45. In the description along the flowchart of FIG. 40, the management device 45 will be described as an operation subject.

In FIG. 40, first, the management device 45 acquires transmitted information 415 transmitted from the drone 470 using the corridor 4 (step S41). For example, the management device 45 acquires transmitted information 415 transmitted from the drone 470 from the management tower 490.

Next, the management device 45 calculates the position of each of the plurality of drones 470 using the position information included in the acquired transmitted information 415 (step S42).

Next, the management device 45 calculates an appropriate arrangement of the drones 470 according to the position relationship of the plurality of drones 470 (step S43).

Next, the management device 45 generates the control information 465 of the drone 470 to be controlled according to the calculated appropriate arrangement (step S44).

Next, the management device 45 outputs the generated control information 465 of the drone 470 to be controlled (step S45). The control information 465 output from the management device 45 is transmitted toward the drone 470 to be controlled via the management tower 490.

### [Monitoring Process]

Next, as an example of the control of the plurality of drones 470 by the management system 400, a monitoring process of issuing a warning to the drone 470 that has not applied for the usage plan of the corridor 4 will be described.

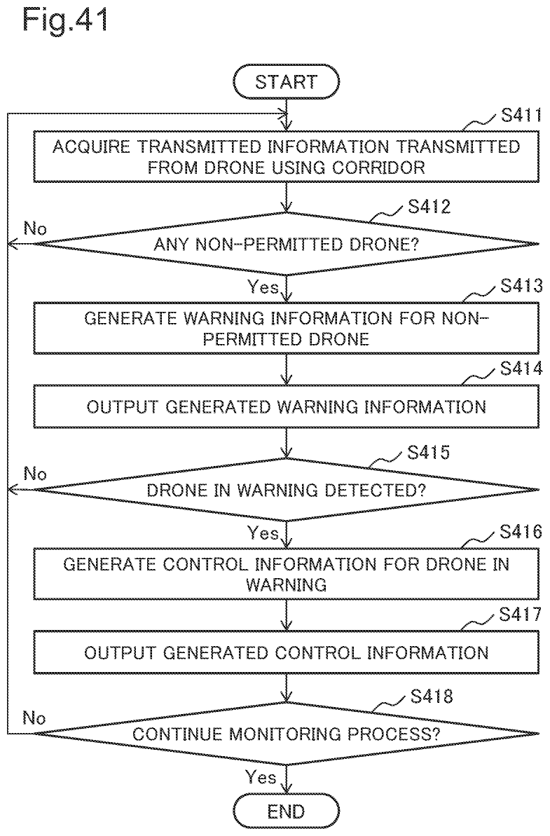

FIG. 41 is a flowchart for explaining a monitoring process by the management system 400. The monitoring process of FIG. 41 includes forced control on the drone 470 that does not follow the warning. Hereinafter, the management device 45 of the management system 400 will be described as an operation subject.

In FIG. 41, first, the management device 45 acquires transmitted information 415 transmitted from the drone using the corridor 4 (step S411).

Next, the management device 45 determines whether the drone 470 is permitted to use the corridor 4 based on the RID of the drone 470 included in the transmitted information 415 (step S412). For example, the management device 45 acquires the RID of the drone 470 that can use the corridor 4 at the present time from the determination device 40, and determines whether the use of the corridor 4 is permitted using the RID.

When the non-permitted drone 470 is using the corridor 4 (Yes in step S412), the management device 45 generates warning information for the non-permitted drone 470 (step S413). When the non-permitted drone 470 is not using the corridor 4 (No in step S412), the process returns to step S411.

After step S413, the management device 45 outputs the generated warning information (step S415). For example, the management device 45 outputs the warning information to the management tower 490. The management tower 490 transmits the warning information to the non-permitted drone 470. For example, in a case where the owner of the non-permitted drone 470 is specified by the RID or the like, the management device 45 may output the warning information to the contact address of the owner.

When the drone 470 in warning is detected (Yes in step S415) at the time when the predetermined waiting period has elapsed after the warning information is output, the management device 45 generates a control condition for the drone 470 in warning (step S416). For example, in step S416, the management device 45 generates a control condition for controlling the drone 470 in such a way as to deviate from the inside of the corridor 4. For example, in step S416, the management device 45 generates a control condition for controlling the drone 470 in such a way as to crash. When the drone 470 in warning is not detected (No in step S415) at the time when the predetermined waiting period has elapsed after the warning information is output, the process returns to step S411.

Next, the management device 45 outputs the generated control information (step S417). For example, the management device 45 outputs control information to the management tower 490. The management tower 490 transmits the control information to the non-permitted drone 470. If the non-permitted drone 470 can be controlled according to the control condition, the drone 470 can be excluded from the inside of the corridor 4. For example, in a case where the non-permitted drone 470 cannot be controlled using the control condition, the drone 470 may be excluded from the inside of the corridor 4 using physical means.

When the monitoring process is continued (Yes in step S418), the process returns to step S411. For example, the monitoring process is continued if in an operation time zone of the corridor 4 defined in advance. When the monitoring process is not continued (No in step S418), the process according to the flowchart of FIG. 41 is ended. For example, the monitoring process is not continued if an operation time zone of the corridor 4 defined in advance is ended. A determination condition for continuation of the monitoring process can be arbitrarily set.

As described above, the management system of the present example embodiment includes the determination device and the management device. The determination device acquires a usage plan of a corridor formed for navigation of the drone. The determination device stores reservation information of the corridor. The determination device refers to the reservation information and calculates a determination parameter relating to congestion in the corridor corresponding to the usage plan. The determination device predicts a congestion status of the corridor according to the calculated determination parameter. The determination device generates determination information including a determination result regarding availability of the corridor and a usage condition of the corridor according to the predicted congestion status of the corridor. The determination device outputs determination information relating to use of the corridor. The management device manages a corridor available to the drone corresponding to the determination information of the determination device.

According to the management system of the present example embodiment, the corridor used by the drone corresponding to the determination information of the determination device can be managed.

In one aspect of the present example embodiment, the management device includes a transmitted information acquisition unit, a position calculation unit, an arrangement calculation unit, a control information generation unit, and a control information output unit. The transmitted information acquisition unit acquires transmitted information including a remote identifier (RID) of a drone using the corridor. The position calculation unit calculates the position of the drone using the position information included in the transmitted information. The arrangement calculation unit calculates the number of drones located in a unit region inside the corridor according to the position of the drone using the corridor. The control information generation unit generates control information for the drone according to the number of drones located in the unit region. The control information output unit outputs the generated control information. According to the present aspect, the drone using the corridor can be controlled based on the transmitted information including the RID of the drone that is using the corridor.

In one aspect of the present example embodiment, the control information generation unit generates control information for controlling the plurality of drones inside the unit region in such a way as to be away from each other in a case where the number of drones inside the unit region exceeds the upper limit number of drones set in the unit region. In a case where the number of drones inside the unit region does not exceed the upper limit number of drones set in the unit region, the control information generation unit does not generate control information for the drone inside the unit region. According to the present aspect, the drone can be controlled according to the number of drones located inside the unit region. In addition, in the present aspect, in a case where the upper limit number of drones set in the unit region is not exceeded, the control information is not generated, and thus the process of controlling the drone navigating inside the corridor is reduced.

In one aspect of the present example embodiment, in a case where a drone that is not permitted to use the corridor is detected inside the corridor, the management device outputs warning information for prompting the detected drone to exit from the corridor. According to the present aspect, unauthorized use of the corridor can be prevented by outputting warning information to a drone that has not received permission to use and its owner.

In one aspect of the present example embodiment, in a case where a drone that is not permitted to use a corridor is detected inside the corridor, the management device outputs control information for performing control for causing the detected drone to exit from the corridor. For example, the management device generates control information that causes the drone to safely crash out of the corridor. According to the present aspect, unauthorized use of the corridor can be prevented by controlling the drone that has not received permission to use to exit from the corridor.

In one aspect of the present example embodiment, the management device forms an emergency corridor in response to an instruction to form an emergency corridor from the determination device. According to the present aspect, in a situation where congestion is occurring in a corridor, an emergency corridor in response to an emergency request can be formed even if the formed corridor cannot be used.

### Fifth Example Embodiment

Next, a determination device according to a fifth example embodiment will be described with reference to the drawings. The determination device of the present example embodiment has a configuration in which the determination devices of the first to fourth example embodiments are simplified.

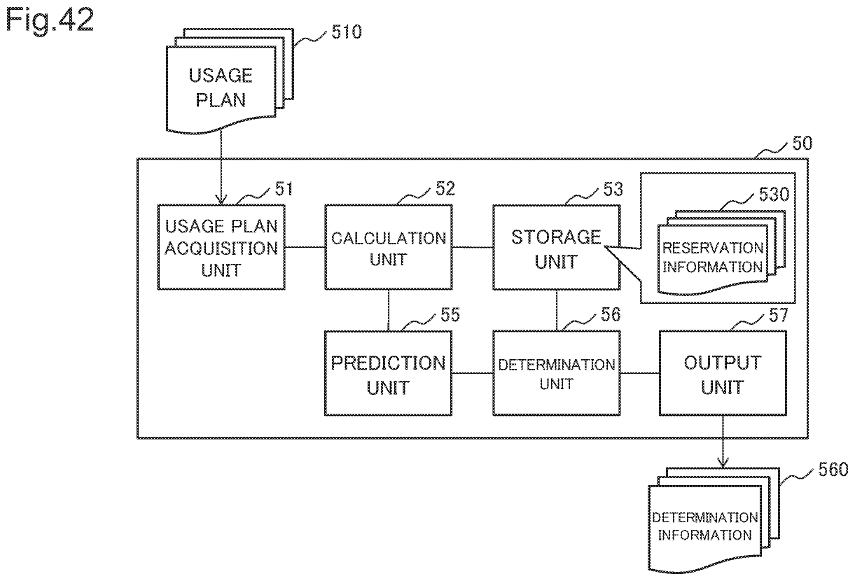

FIG. 42 is a block diagram illustrating an example of a configuration of a determination device 50 according to the present example embodiment. The determination device 50 includes a usage plan acquisition unit 51, a calculation unit 52, a storage unit 53, a prediction unit 55, a determination unit 56, and an output unit 57.

The usage plan acquisition unit 51 acquires a usage plan 510 of a corridor formed for navigation of the drone. The storage unit 53 stores the reservation information 530 of the corridor. The calculation unit 52 refers to the reservation information 530 and calculates a determination parameter relating to congestion in the corridor corresponding to the usage plan 510. The prediction unit 55 predicts a congestion status of the corridor according to the calculated determination parameter. The determination unit 56 generates the determination information 560 regarding availability of the corridor in accordance with the predicted traffic congestion status of the corridor. The output unit 57 outputs determination information 560 relating to the availability of the corridor.

As described above, the determination device of the present example embodiment predicts a congestion status that may occur in the corridor when the usage plan is accepted in response to the application for the usage plan. The determination device according to the present example embodiment determines to permit/not to permit the use of the corridor according to the predicted congestion status. Therefore, according to the present example embodiment, it is possible to resolve congestion that may occur in a corridor through which a drone navigates.

### (Hardware)

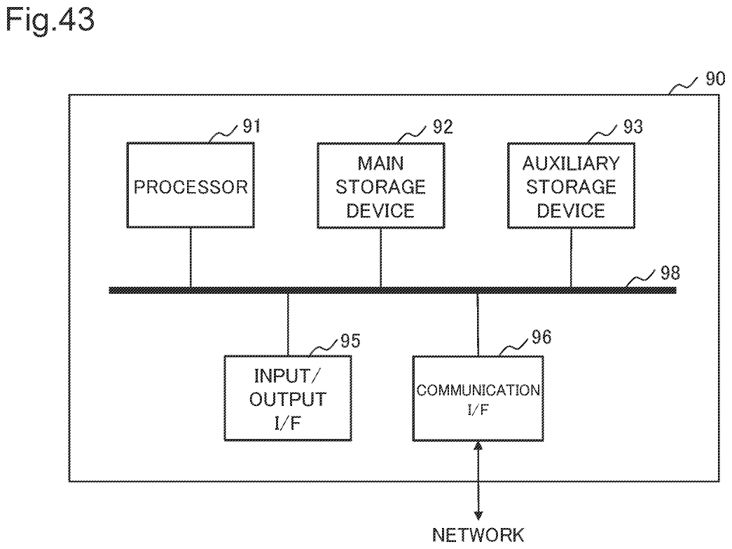

Here, a hardware configuration for executing control and process according to each example embodiment of the present disclosure will be described using an information processing device 90 of FIG. 43 as an example. The information processing device 90 in FIG. 43 is a configuration example for executing control and process of each example embodiment, and does not limit the scope of the present disclosure.

As illustrated in FIG. 43, the information processing device 90 includes a processor 91, a main storage device 92, an auxiliary storage device 93, an input/output interface 95, and a communication interface 96. In FIG. 43, the interface is abbreviated as an interface (I/F). The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a configuration of using a software program installed in the information processing device 90 may be adopted. The processor 91 executes control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). In addition, a nonvolatile memory such as a magnetoresistive random access memory (MRAM) may be configured/added as the main storage device 92.

The auxiliary storage device 93 stores various data such as programs. The auxiliary storage device 93 is achieved by a local disk such as a hard disk or a flash memory. Note that various data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface to connect to an external device.

Input devices such as a keyboard, a mouse, and a touch panel may be connected to the information processing device 90 as necessary. These input devices are used to input information and settings. Note that when the touch panel is used as the input device, the display screen of the display device may also serve as the interface of the input device. Data communication between the processor 91 and the input device may be mediated by the input/output interface 95.

Furthermore, the information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

Furthermore, the information processing device 90 may be provided with a drive device. The drive device mediates reading of data and a program from a recording medium, writing of a processing result of the information processing device 90 to the recording medium, and the like between the processor 91 and the recording medium (program recording medium). The display device may be connected to the information processing device 90 via the input/output interface 95.

The above is an example of a hardware configuration for enabling control and process according to each example embodiment of the present invention. The hardware configuration of FIG. 43 is an example of a hardware configuration for executing control and process according to each example embodiment, and does not limit the scope of the present invention. In addition, a program for causing a computer to execute control and process according to each example embodiment is also included in the scope of the present invention. Furthermore, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium. When a program executed by the processor is recorded in a recording medium, the recording medium corresponds to a program recording medium.

The components of each example embodiment may be arbitrarily combined. In addition, the components of each example embodiment may be achieved by software or may be achieved by a circuit.

Although the present invention has been described with reference to the example embodiments, the present invention is not limited to the above example embodiments. Various modifications that can be understood by those skilled in the art can be made to the configuration and details of the present invention within the scope of the present invention.

Some or all of the above example embodiments may be described as the following supplementary notes, but are not limited to the following.

### (Supplementary Note 1)

A determination device including:
a usage plan acquisition unit that acquires a usage plan of a corridor formed for navigation of a drone;
a storage unit that stores reservation information of the corridor;
a calculation unit that calculates a determination parameter relating to congestion in the corridor corresponding to the usage plan by referring to the reservation information;
a prediction unit that predicts a congestion status of the corridor according to the calculated determination parameter;
a determination unit that generates determination information relating to availability of the corridor according to the predicted congestion status of the corridor; and
an output unit that outputs the determination information relating to availability of the corridor.

### (Supplementary Note 2)

The determination device according to supplementary note 1, wherein the determination unit
permits use of the corridor in a case where it is predicted that congestion will not occur in the corridor in response to acceptance of the usage plan, and
does not permit use of the corridor in a case where it is predicted that congestion will occur in the corridor in response to acceptance of the usage plan.

### (Supplementary Note 3)

The determination device according to supplementary note 1 or 2, wherein
the determination unit
presents an alternative plan relating to use of the corridor in a case where it is predicted that congestion will occur in the corridor in response to acceptance of the usage plan.

### (Supplementary Note 4)

The determination device according to any one of supplementary notes 1 to 3, wherein
the prediction unit
predicts the congestion status of the corridor according to a ratio of number of drones that made the reservation corresponding to the usage plan with respect to an upper limit number of drones allowed for each of a plurality of corridor regions constituting the corridor.

### (Supplementary Note 5)

The determination device according to supplementary note 4, wherein
the prediction unit
predicts that congestion will not occur in the corridor when the ratio of a number of drones that made the reservation corresponding to the usage plan with respect to the upper limit number of drones allowed for each of the plurality of corridor regions constituting the corridor is less than or equal to 1, and
predicts that that congestion will occur in the corridor when the ratio of the number of drones that made the reservation corresponding to the usage plan with respect to the upper limit number of drones allowed for each of the plurality of corridor regions constituting the corridor exceeds 1.

### (Supplementary Note 6)

The determination device according to any one of supplementary notes 1 to 3, wherein
the prediction unit
predicts the congestion status of the corridor according to a value obtained by subtracting the number of drones that made the reservation corresponding to the usage plan from the upper limit number of drones allowed for each of a plurality of corridor regions constituting the corridor.

### (Supplementary Note 7)

The determination device according to supplementary note 6, wherein
the prediction unit
predicts that congestion will not occur in the corridor when the value obtained by subtracting the number of drones that made the reservation corresponding to the usage plan from the upper limit number of drones allowed for each of the plurality of corridor regions constituting the corridor is greater than or equal to zero, and
predicts that that congestion will occur in the corridor when the value obtained by subtracting the number of drones that made the reservation corresponding to the usage plan from the upper limit number of drones allowed for each of the plurality of corridor regions constituting the corridor is less than 0.

### (Supplementary Note 8)

The determination device according to any one of supplementary notes 1 to 7, wherein
the usage plan acquisition unit acquires the usage plan including a charge amount of the drone planning to use the corridor; and
the determination unit determines availability of the corridor according to a charge amount of the drone included in the usage plan.

### (Supplementary Note 9)

The determination device according to supplementary note 8, wherein
the storage unit stores the reservation information including information relating to a charging station usable when using the corridor; and
the determination unit generates caution information relating to use of the corridor according to a reservation status of the charging station included in the reservation information when the charge amount of the drone included in the usage plan is insufficient.

### (Supplementary Note 10)

The determination device according to any one of supplementary notes 1 to 9, further comprising:
an environment information acquisition unit that acquires environment information of the corridor, wherein
the determination unit determines availability of the corridor according to a status of the corridor included in the environment information.

### (Supplementary Note 11)

The determination device according to any one of supplementary notes 1 to 10, wherein
the output unit
outputs a reservation status of the corridor to a terminal device used by a user who has applied for the usage plan, and displays the reservation status of the corridor on a screen of the terminal device used by the user.

### (Supplementary Note 12)

The determination device according to supplementary note 11, wherein
the usage plan acquisition unit
acquires the usage plan input according to an operation on the reservation status of the corridor displayed on the terminal device; and
the output unit
outputs the determination information determined according to the usage plan to the terminal device.

### (Supplementary Note 13)

A management system comprising:
the determination device according to any one of supplementary notes 1 to 12; and
a management device that manages a corridor available to the drone according to the determination information of the determination device.

### (Supplementary Note 14)

The management system according to supplementary note 13, wherein
the management device includes:
a transmitted information acquisition unit that acquires transmitted information including a remote identifier (RID) of the drone using the corridor;
a position calculation unit that calculates a position of the drone by using position information included in the transmitted information;
an arrangement calculation unit that calculates number of drones located in a unit region inside the corridor according to the position of the drone using the corridor;
a control information generation unit that generates control information for the drone according to the number of drones located in the unit region; and
a control information output unit that outputs the generated control information.

### (Supplementary Note 15)

The management system according to supplementary note 14, wherein
the control information generation unit
generates the control information for controlling the plurality of drones inside the unit region to move away from each other in a case where the number of drones inside the unit region exceeds an upper limit number of drones set in the unit region, and
does not generate the control information for the drone inside the unit region in a case where the number of drones inside the unit region does not exceed the upper limit number of drones set in the unit region.

### (Supplementary Note 16)

The management system according to supplementary note 14 or 15, wherein
when the drone that is not permitted to use the corridor is detected inside the corridor,
the management device
outputs warning information for prompting the detected drone to exit from the corridor.

### (Supplementary Note 17)

The management system according to supplementary note 15 or 16, wherein
when the drone that is not permitted to use the corridor is detected inside the corridor,
the management device
outputs the control information for controlling the detected drone to exit from the corridor.

### (Supplementary Note 18)

The management system according to any one of supplementary notes 13 to 17, wherein
the determination device
determines whether to form an emergency corridor according to a usage status of the corridor in a case where an emergency request of the corridor is acquired as the usage plan,
outputs an instruction to form the emergency corridor to the management device in a case where the formation of the emergency corridor is possible, and
outputs determination information including a determination result relating to use of the emergency corridor to a request source of the emergency request; and
the management device forms the emergency corridor in response to the instruction to form the corridor from the determination device.

### (Supplementary Note 19)

A determination method in which a computer:
acquires a usage plan of a corridor formed for navigation of a drone;
stores reservation information of the corridor; calculates a determination parameter relating to congestion in the corridor corresponding to the usage plan by referring to the reservation information; predicts a congestion status of the corridor according to the calculated determination parameter;
generates determination information relating to availability of the corridor according to the predicted congestion status of the corridor; and
outputs the determination information relating to availability of the corridor.

### (Supplementary Note 20)

A program for causing a computer to execute:
a process of acquiring a usage plan of a corridor formed for navigation of a drone;
a process of storing reservation information of the corridor;
a process of calculating a determination parameter relating to congestion in the corridor corresponding to the usage plan by referring to the reservation information;
a process of predicting a congestion status of the corridor according to the calculated determination parameter;
a process of generating determination information relating to availability of the corridor according to the predicted congestion status of the corridor; and
a process of outputting the determination information relating to availability of the corridor.

### REFERENCE SIGNS LIST

10, 20, 30, 40, 50 determination device
11, 21, 31, 51 usage plan acquisition unit
12, 22, 32, 52 calculation unit
13, 23, 33, 53 storage unit
15, 25, 35, 55 prediction unit
16, 26, 36, 56 determination unit
17, 27, 37, 57 output unit
34 environment information acquisition unit
45 management device
100, 200 terminal device
140, 240, 340, 440 guide lamp
170, 270, 370, 470 drone
190, 290, 390, 490 management tower
347 anemometer
400 management system
451 transmitted information acquisition unit
452 position calculation unit
453 arrangement calculation unit
455 control information generation unit
457 control information output unit
471 main body
472 propeller
473 flight control unit
475 camera
476 imaging control unit
477 transmitted information generation unit
479 rechargeable battery

What is claimed is:

1. A determination device comprising:
a memory storing instructions; and
a processor connected to the memory and configured to execute the instructions to:
acquire a usage plan of a corridor formed for navigation of a drone;
store reservation information of the corridor;
calculate a determination parameter relating to congestion in the corridor corresponding to the usage plan by referring to the reservation information;
predict a congestion status of the corridor according to the calculated determination parameter;
generate determination information relating to availability of the corridor according to the predicted congestion status of the corridor; and
output the determination information relating to availability of the corridor.

2. The determination device according to claim 1, wherein
the processor is configured to execute the instructions to
permit use of the corridor in a case where it is predicted that congestion will not occur in the corridor in response to acceptance of the usage plan, and
do not permit use of the corridor in a case where it is predicted that congestion will occur in the corridor in response to acceptance of the usage plan.

3. The determination device according to claim 1, wherein
the processor is configured to execute the instructions to
present an alternative plan relating to use of the corridor in a case where it is predicted that congestion will occur in the corridor in response to acceptance of the usage plan.

4. The determination device according to claim 1, wherein
the processor is configured to execute the instructions to
predict the congestion status of the corridor according to a ratio of number of drones that made the reservation corresponding to the usage plan with respect to an upper limit number of drones allowed for each of a plurality of corridor regions constituting the corridor.

5. The determination device according to claim 4, wherein
the processor is configured to execute the instructions to predict that congestion will not occur in the corridor when the ratio of the number of drones that made the reservation corresponding to the usage plan with respect to the upper limit number of drones allowed for each of the plurality of corridor regions constituting the corridor is less than or equal to 1, and
predict that that congestion will occur in the corridor when the ratio of the number of drones that made the reservation corresponding to the usage plan with respect to the upper limit number of drones allowed for each of the plurality of corridor regions constituting the corridor exceeds one.

6. The determination device according to claim 1, wherein
the processor is configured to execute the instructions to
predict the congestion status of the corridor according to a value obtained by subtracting the number of drones that made the reservation corresponding to the usage plan from the upper limit number of drones allowed for each of a plurality of corridor regions constituting the corridor.

7. The determination device according to claim 6, wherein
the processor is configured to execute the instructions to
predict that congestion will not occur in the corridor when the value obtained by subtracting the number of drones that made the reservation corresponding to the usage plan from the upper limit number of drones allowed for each of the plurality of corridor regions constituting the corridor is greater than or equal to zero, and
predict that that congestion will occur in the corridor when the value obtained by subtracting the number of drones that made the reservation corresponding to the usage plan from the upper limit number of drones allowed for each of the plurality of corridor regions constituting the corridor is less than 0.

8. The determination device according to claim 1, wherein
the processor is configured to execute the instructions to
acquire the usage plan including a charge amount of the drone planning to use the corridor, and
determine availability of the corridor according to a charge amount of the drone included in the usage plan.

9. The determination device according to claim 8, wherein
the processor is configured to execute the instructions to
store the reservation information including information relating to a charging station usable when using the corridor, and
generate caution information relating to use of the corridor according to a reservation status of the charging station included in the reservation information when the charge amount of the drone included in the usage plan is insufficient.

10. The determination device according to claim 1, wherein
the processor is configured to execute the instructions to
acquire environment information of the corridor, and
determine availability of the corridor according to a status of the corridor included in the environment information.

11. The determination device according to claim 1, wherein
the processor is configured to execute the instructions to
output a reservation status of the corridor to a terminal device used by a user who has applied for the usage plan, and displays the reservation status of the corridor on a screen of the terminal device used by the user.

12. The determination device according to claim 11, wherein
the processor is configured to execute the instructions to
acquire the usage plan input according to an operation on the reservation status of the corridor displayed on the terminal device, and
output the determination information determined according to the usage plan to the terminal device.

13. A management system comprising:
the determination device according to claim 1; and
a management device configured to manage a corridor available to the drone according to the determination information of the determination device.

14. The management system according to claim 13, wherein
the management device includes:
a memory storing instructions; and
a processor connected to the memory and configured to execute the instructions to:
acquire transmitted information including a remote identifier (RID) of the drone using the corridor;
calculate a position of the drone by using position information included in the transmitted information;
calculate number of drones located in a unit region inside the corridor according to the position of the drone using the corridor;
generate control information for the drone according to the number of drones located in the unit region, and;
output the generated control information.

15. The management system according to claim 14, wherein
the processor of the management device is configured to execute the instructions to
generate the control information for controlling the plurality of drones inside the unit region to move away from each other in a case where the number of drones inside the unit region exceeds an upper limit number of drones set in the unit region, and
do not generate the control information for the drone inside the unit region in a case where the number of drones inside the unit region does not exceed the upper limit number of drones set in the unit region.

16. The management system according to claim 14, wherein
in the case of detecting the drone inside the corridor and the detected drone is not permitted to use the corridor,
the processor of the management device is configured to execute the instructions to
output warning information for prompting the detected drone to exit from the corridor.

17. The management system according to claim 15, wherein
in the case of detecting the drone inside the corridor and the detected drone is not permitted to use the corridor,
the processor of the management device is configured to execute the instructions to
output the control information for controlling the detected drone to exit from the corridor.

18. The management system according to claim 13, wherein
the processor of the determination device is configured to execute the instructions to
determine whether to form an emergency corridor according to a usage status of the corridor in a case where an emergency request of the corridor is acquired as the usage plan,
output an instruction to form the emergency corridor to the management device in a case where the formation of the emergency corridor is possible, and
output determination information including a determination result relating to use of the emergency corridor to a request source of the emergency request, and
the processor of the management device is configured to execute the instructions to
form the emergency corridor in response to the instruction to form the corridor from the determination device.

19. A determination method causing a computer to execute:
acquiring a usage plan of a corridor formed for navigation of a drone;
storing reservation information of the corridor; calculates a determination parameter relating to congestion in the corridor corresponding to the usage plan by referring to the reservation information; predicts a congestion status of the corridor according to the calculated determination parameter;
generating determination information relating to availability of the corridor according to the predicted congestion status of the corridor; and
outputting the determination information relating to availability of the corridor.

20. A non-transient recording medium recorded with a program for causing a computer to execute:
a process of acquiring a usage plan of a corridor formed for navigation of a drone;
a process of storing reservation information of the corridor;
a process of calculating a determination parameter relating to congestion in the corridor corresponding to the usage plan by referring to the reservation information;
a process of predicting a congestion status of the corridor according to the calculated determination parameter;
a process of generating determination information relating to availability of the corridor according to the predicted congestion status of the corridor; and
a process of outputting the determination information relating to availability of the corridor.
